(19) United States
(12) Patent Application Publication
(10) Pub. No.: US 2019/0127564 A1
(43) Pub. Date: May 2, 2019

(54) ELASTOMER PRECURSOR COMPRISING THERMOPLASTIC VULCANIZATE OR RUBBER PARTICLES INCORPORATED INTO A THERMOPLASTIC POLYMER IN A RUBBER MATRIX

(71) Applicant: ENRAD LTD., Moshav Shahar (IL)

(72) Inventors: Nitzan Eliyahu, Moshav Shahar (IL); Mirco Pellegrini, Tione di Trento (IT)

(73) Assignee: ENRAD LTD., Moshav Shahar (IL)

(21) Appl. No.: 15/891,499

(22) Filed: Feb. 8, 2018

Related U.S. Application Data
(62) Division of application No. 14/394,128, filed on Oct. 13, 2014, now abandoned.
(60) Provisional application No. 61/624,447, filed on Apr. 16, 2012.

(51) Int. Cl. C08L 23/16; C08J 3/00; C08L 21/00; B01L 3/00; C09K 3/10; C08J 3/24; C08K 5/14; F28D 20/02

(52) U.S. Cl. CPC C08L 23/16; C08L 2205/025; C08L 21/00; B01L 3/502707; C09K 3/1006; C08J 3/24; C08K 5/14; F28D 20/023; Y02E 60/145; C08L 2312/00; C08J 2423/16; C08J 2423/12; C08J 2323/16; B01L 2300/0864; B01L 2300/0867; B01L 2300/123; B01L 2400/0481; B01L 2400/0655; C09K 2003/1053; C09K 2200/0642; C08J 3/005

(57) ABSTRACT

A precursor to an elastomeric composition with improved properties is disclosed. The precursor comprises a cross-linkable rubber, a thermoplastic vulcanizate, and a cross-linking agent. An elastomeric composition produced by cross-linking of the rubber in the precursor and methods for manufacture of the precursor and the elastomeric composition are disclosed as well.

### CROSS-REFERENCE TO RELATED APPLICATIONS

This Application is a Divisional Application from U.S. application Ser. No. 14/394,128 filed on Oct. 13, 2014; which is a National Phase Application of PCT International Application No. PCT/IL2013/050323, International Filing Date Apr. 14, 2013; which claims the benefit of U.S. Provisional Patent Application No. 61/624,447 filed on Apr. 16, 2012 which are incorporated in their entirety herein by reference.

### FIELD OF THE INVENTION

This invention relates in general to precursors to elastomer compositions, methods for making them, and elastomers formed from such precursors. In particular, it relates to precursors to elastomer compositions that combine natural or synthetic rubber with thermoplastic vulcanizates, microparticles of thermoplastic vulcanizates, thermoplastics that comprise microparticles of rubber, or thermoplastics that comprise microparticles of recycled rubber.

### BACKGROUND OF THE INVENTION

Vulcanization (the use of sulfur to cross-link polymer chains) of rubber was discovered more than a century and a half ago. Since then, cross-linked elastomer compositions based on natural or synthetic rubber have found uses ranging from automotive to medical to printing.

Nonetheless, the properties of rubber are not always ideal for the applications to which they are put. For example, flexographic printing uses rubber engraving plates, but the quality of the resultant print is sometimes limited by the inherent limitations in the quality of plates produced from rubber, e.g. the limited stiffness of the rubber sheet, the necessity for inclusion of plasticizers that leach out from the plate, etc. For example, to obtain good mechanical characteristics, the compound must be mixed with so called “reinforcing fillers” such as carbon black or silica. Without the reinforcing fillers, the mechanical characteristics of the rubber compound are too weak.

In many cases, despite the drawbacks of rubber, other elastomers are also inappropriate for use in a particular application. For example, while thermoplastic polymers require little or no compounding, they lack elastic properties, and in general it is not possible to modify significantly their characteristics by changes in formulation, thus limiting the types of applications for which they are suitable.

Thus, there remains a long-felt need for a formulation that can be used to produce an elastomer that combines the advantageous properties of rubber (low cost, high chemical and heat resistance, ability to be loaded with filler) with the advantageous properties of other elastomers such as thermoplastic polymers.

### SUMMARY OF THE INVENTION

The present invention is designed to meet this long-felt need. In particular, precursors to elastomeric materials are disclosed in which the precursor comprises a mixture of natural and/or synthetic rubber and a thermoplastic vulcanizate (TPV) along with a cross-linking agent along with methods for making these precursors, methods for using the precursors to prepare elastomeric materials, and the elastomeric materials produced therefrom. The inventors have discovered, surprisingly, that a combination of rubber and TPV provides the final elastomer product with physical properties such as stiffness, elasticity, and rheological properties that are superior either to that of rubber or TPV alone. In addition, the precursor combines desirable plastic properties of TPV with the ability of rubber to tolerate fillers such as carbon black. In some embodiments, the precursor is free of plasticizers or other additives that may leach out during use, cause formation of bubbles in the elastomer sheet, etc.

It is therefore an object of the present invention to disclose a precursor to an elastomeric material, said precursor comprising: rubber; a material incorporated into said rubber, said material selected from the group consisting of thermoplastic vulcanizate (TPV), microparticles of TPV, thermoplastic incorporating microparticles of rubber, and any combination thereof, and at least one cross-linking agent.

It is a further object of this invention to disclose such a precursor, wherein said microparticles of rubber comprise microparticles of recycled rubber.

It is a further object of this invention to disclose such a precursor as defined in any of the above, wherein said rubber is selected from the group consisting of natural rubber (NR), nitrile butadiene rubber (NBR), hydrogenated nitrile butadiene rubber (HNBR), carboxylated nitrile rubber (XNBR), butyl rubber (IIR), chlorobutyl rubber (CIIR), bromobutyl rubber (BIIR), polychloroprene (CR), styrene-butadiene rubber (SBR), polybutadiene (BR), ethylene-propylene-diene tripolymer (EPDM), ethylene-propylene rubber (EPM), silicone rubber, acrylic rubber (ACM), ethylene-vinylacetate copolymer rubber (EVM), polyurethane rubber (PU), and any combination of the above.

It is a further object of this invention to disclose such a precursor as defined in any of the above, wherein said TPV is selected from the group consisting of TPVs of the following types of rubber: polypropylene/EPDM (ppEPDM), thermoplastc-silicone mixtures, styrene-based thermoplastic vulcanizates, poly(styrene-butadiene-styrene) (SBS), styrene isoprene butadiene (SIBS), acrylonitrile butadiene styrene (ABS), styrene-ethylene-butylene-styrene copolymer (SEBS), polyethylene/EPDM (peEPDM), polyethylene/EPM, polyurethane (PU), polyamide/acrylic rubber (paACM), and thermoplastic polyester elastomer/ethylene-vinylacetate copolymer rubber (tpc-etEVM). In some embodiments of the invention, said TPV is selected from the group consisting of ppEPDM, peEPDM paACM or tpc-etEVM.

It is a further object of this invention to disclose such a precursor as defined in any of the above, wherein said rubber is EPDM and said TPV is ppEPDM.

It is a further object of this invention to disclose such a precursor as defined in any of the above, wherein said rubber is EPDM and said TPV is peEPDM.

It is a further object of this invention to disclose such a precursor as defined in any of the above, wherein said rubber is ACM and said TPV is paACM

It is a further object of this invention to disclose such a precursor as defined in any of the above, wherein said rubber is EVM and said TPV is tpc-etEVM.

It is a further object of this invention to disclose such a precursor as defined in any of the above, wherein said cross-linking agent is selected from the group consisting of sulfur peroxides and amines. In some embodiments of the invention, said cross-linking agent is a peroxide selected from the group consisting of butyl-4,4-di(tert-butylperoxy)valerate; di(tert-butyl) peroxide; di(tert-butylperoxyisopropyl)benzene; dicumyl peroxide; and 2,5-dimethyl-2,5-bis-(tert-butylperoxy)hexane.

It is a further object of this invention to disclose such a precursor as defined in any of the above, wherein the weight ratio of said rubber to material selected from the group consisting of thermoplastic vulcanizate (TPV), thermoplastic incorporating microparticles of rubber and any combination thereof is between 90:10 and 10:90. In some embodiments of the invention, the weight ratio of said rubber to material selected from the group consisting of thermoplastic vulcanizate (TPV), thermoplastic incorporating microparticles of rubber and any combination thereof is between 70:30 and 30:70.

It is a further object of this invention to disclose such a precursor as defined in any of the above, additionally comprising a cross-linking co-agent. In some embodiments of the invention, said cross-linking co-agent is an acrylate, a triazine, or 1,8-diazabicyclo-5,4,0-undec-7-ene (DBU) with saturated dibasic acids. In some embodiments of the invention, said cross-linking co-agent is trimethyl-ol-propane-trimethylacrylate (TMPTMA).

It is a further object of this invention to disclose such a precursor as defined in any of the above, additionally comprising at least one inorganic filler. In some embodiments of the invention, said filler comprises a substance selected from the group consisting of silica, mica, kaolin, clay, coal dust, lignin, talc, BaSO₄, CaCO₃, Al(OH)₃, Mg(OH)₂, ZnO, and MgO. In some embodiments of the invention, said precursor comprises between 1% and 70% by weight inorganic filler.

It is a further object of this invention to disclose such a precursor as defined in any of the above, additionally comprising carbon black. In some embodiments of the invention, wherein said precursor comprises between 1% and 60% by weight carbon black. In some embodiments of the invention, said precursor comprises between 5% and 35% by weight carbon black.

It is a further object of this invention to disclose such a precursor as defined in any of the above, wherein said precursor is free of any process oil.

It is a further object of this invention to disclose such a precursor as defined in any of the above, wherein said precursor is free of any plasticizer.

It is a further object of this invention to disclose such a precursor as defined in any of the above, additionally comprising plasticizer.

It is a further object of this invention to disclose such a precursor as defined in any of the above, additionally comprising at least one material selected from the group consisting of anti-ozonants, anti-aging materials, and anti-degradants.

It is a further object of this invention to disclose a method for making a precursor to an elastomeric material, wherein said method comprises (a) mixing rubber and at least one material selected from the group consisting of TPV, thermoplastic incorporating microparticles of rubber and any combination thereof; and (b) adding at least one cross-linking agent.

It is a further object of this invention to disclose such a method, wherein said rubber is selected from the group consisting of natural rubber (NR), nitrile butadiene rubber (NBR), hydrogenated nitrile butadiene rubber (HNBR), carboxylated nitrile rubber (XNBR), butyl rubber (IIR), chlorobutyl rubber (CIIR), bromobutyl rubber (BIIR), polychloroprene (CR), styrene-butadiene rubber (SBR), polybutadiene (BR), ethylene-propylene-diene tripolymer (EPDM), ethylene-propylene rubber (EPM), silicone rubber, acrylic rubber (ACM), ethylene vinylacetate copolymer rubber (EVM), polyurethane rubber (PU) and any combination of the above, and said TPV is selected from the group consisting of TPVs of the following types rubber: ppEPDM, thermoplastc-silicone mixtures, styrene-based thermoplastic vulcanizates, poly(styrene-butadiene-styrene) (SBS), styrene isoprene butadiene (SIBS), acrylonitrile butadiene styrene (ABS), styrene-ethylene-butylene-styrene copolymer (SEBS), polyethylene/EPDM (peEPDM), polyethylene/EPM (peEPM), polyurethane (PU), polyamide/acrylic rubber (paACM), and thermoplastic polyester elastomer/ethylene-vinylacetate copolymer rubber (tpc-etEVM).

It is a further object of this invention to disclose such a method as defined in any of the above, wherein said step of mixing takes place within at least one apparatus selected from the group consisting of mixers, extruders, and mills.

It is a further object of this invention to disclose such a method as defined in any of the above, wherein said step of mixing comprises mixing at an operating temperature above the melting point of said TPV.

It is a further object of this invention to disclose such a method as defined in any of the above, wherein said step of mixing comprises mixing at an operating temperature of between 150 and 270° C.

It is a further object of this invention to disclose such a method as defined in any of the above, wherein said step of mixing comprises mixing until a constant stress is observed.

It is a further object of this invention to disclose such a method as defined in any of the above, wherein said step of mixing comprises a step of mixing rubber and material selected from the group consisting of TPV, thermoplastic incorporating microparticles of rubber, and any combination thereof in a weight ratio (rubber: other substances) of between 90:10 and 10:90. In some embodiments of the invention, said step of mixing comprises a step of mixing rubber and material selected from the group consisting of TPV, thermoplastic incorporating microparticles of rubber, and any combination thereof in a weight ratio (rubber: other substances) of between 70:30 and 30:70.

It is a further object of this invention to disclose such a method as defined in any of the above, wherein said step of adding at least one cross-linking agent comprises adding at least one cross-linking agent selected from the group consisting of sulfur, peroxides, or amines. In some embodiments of the invention, said step of adding at least one cross-linking agent comprises adding at least one peroxide selected from the group consisting of butyl-4,4-di(tert-butylperoxy)valerate; di(tert-butyl) peroxide; di(tert-butylperoxyisopropyl)benzene; dicumyl peroxide; and 2,5-dimethyl-2,5-bis-(tert-butylperoxy)hexane.

It is a further object of this invention to disclose such a method as defined in any of the above, wherein said step of mixing takes place in an internal mixer, and additionally comprising a step of recompounding on a two-roll mill, said step of adding cross-linker taking place at least partially during the performance of said step of recompounding.

It is a further object of this invention to disclose such a method as defined in any of the above, additionally comprising a step of adding carbon black. In some embodiments of the invention, said step of adding carbon black comprises adding between 1% and 60% by weight carbon black. In some embodiments of the invention, said step of adding carbon black comprises adding between 5% and 35% by weight carbon black. In some embodiments of the invention, said step of mixing comprises mixing said rubber and said material selected from the group consisting of TPV, thermoplastic incorporating microparticles of rubber, and any combination thereof within an internal mixer, said step of adding carbon black comprises adding carbon black to said internal mixer, and said step of adding at least one cross-linking agent comprises adding cross-linking agent to the mixture after it has been removed from said mixer.

It is a further object of this invention to disclose such a method as defined in any of the above, additionally comprising a step of adding a cross-linking co-agent during or after said step of mixing. In some embodiments of the invention, said step of adding a cross-linking co-agent comprises adding TMPTMA. In some embodiments of the invention, said step of mixing comprises mixing said rubber and said material selected from the group consisting of TPV, thermoplastic incorporating microparticles of rubber, and any combination thereof within an internal mixer, said step of adding at least one cross-linking agent comprises adding cross-linking agent to the mixture after it has been removed from said mixer, and said step of adding at least one cross-linking co-agent comprises adding said cross-linking co-agent to the mixture during mixing, or after it has been removed from said mixer.

It is a further object of this invention to disclose such a method as defined in any of the above, additionally comprising a step of compounding said rubber and said TPV on a mill, said step of compounding taking place after said step of mixing. In some embodiments of the invention, said step of compounding takes place prior to said step of adding at least one cross-linking agent. In some embodiments of the invention, said step of adding at least one cross-linking agent takes place at least partially while said step of compounding is taking place.

It is a further object of this invention to disclose such a method as defined in any of the above, additionally comprising a step of depositing the mixture produced in said step of mixing onto a fabric base while feeding through a calendar, thereby producing a continuous roll of material.

It is a further object of this invention to disclose such a method as defined in any of the above, additionally comprising: (a) dissolving the mixture produced in said step of mixing in a solvent; and (b) producing a continuous roll of material by a method chosen from the group consisting of: (i) dipping a fabric into the solution produced in said step of dissolving; and (ii) spread-coating a fabric with the solution produced in said step of dissolving.

It is a further object of this invention to disclose such a method as defined in any of the above, additionally comprising a step of feeding the material produced in said step of adding a cross-linking agent into an apparatus selected from the group consisting of autoclaves, ovens and rotocures, and further wherein said step of activating said cross-linking agent occurs at least partially within said apparatus.

It is a further object of this invention to disclose such a method as defined in any of the above, additionally comprising a step of grinding the at least partially cross-linked material produced in said step of activating said cross-linking agent.

It is a further object of this invention to disclose such a method as defined in any of the above, additionally comprising a step of adding inorganic filler. In some embodiments of the invention, said step of adding inorganic filler comprises a step of adding a filler comprising at least one substance selected from the group consisting of silica, mica, kaolin, clay, coal dust, lignin, talc, BaSO₄, CaCO₃, Al(OH)₃, Mg(OH)₂, ZnO, and MgO, said step of adding inorganic filler taking place prior to or substantially concurrent with said step of adding at least one cross-linking agent.

It is a further object of this invention to disclose such a method as defined in any of the above, additionally comprising a step of injecting a pressurized gas during said step of mixing. In some embodiments of the invention, said pressurized gas comprises CO₂.

It is a further object of this invention to disclose such a method as defined in any of the above, wherein said step of mixing comprises mixing at an operating temperature above the melting point of said TPV.

It is a further object of this invention to disclose such a method as defined in any of the above, wherein said step of mixing comprises mixing at an operating temperature of between 150 and 270° C.

It is a further object of this invention to disclose such a method as defined in any of the above, wherein said step of mixing said mixture comprises a step of mixing said mixture until a constant stress is observed.

It is a further object of this invention to disclose such a method as defined in any of the above, wherein said method does not comprise any step of adding plasticizer.

It is a further object of this invention to disclose such a method as defined in any of the above, additionally comprising a step of adding plasticizer.

It is a further object of this invention to disclose such a method as defined in any of the above, additionally comprising a step of feeding said mixture into a mill following said step of mixing. In some embodiments of the invention, said step of adding a cross-linking agent occurs subsequent to said step of feeding said mixture into a mill.

It is a further object of this invention to disclose such a method as defined in any of the above, wherein said step of mixing comprises mixing all components of said compound precursor except for said cross-linking agent within an apparatus selected from the group consisting of extruders and mixers.

It is a further object of this invention to disclose a method of making an elastomeric material, comprising (a) making a precursor to an elastomeric material by any method defined above, and (b) activating said cross-linking agent.

It is a further object of this invention to disclose such a method for making an elastomeric material, wherein said step of activating said cross-linking agent additionally comprises a step of initiating said step of cross-linking by a method selected from the group consisting of heating and irradiating with UV light.

It is a further object of this invention to disclose such a method for making an elastomeric material, additionally comprising a step of feeding the material produced in said step of adding a cross-linking agent into an apparatus selected from the group consisting of autoclaves, ovens and rotocures, and further wherein said step of activating said cross-linking agent occurs at least partially within said apparatus.

It is a further object of this invention to disclose a method for making an elastomeric material as defined above, wherein said step of mixing comprises mixing 60 parts by weight of EPDM with 40 parts by weight of ppEPDM at a mixer operating temperature of between 170 and 220° C.; said step of adding a cross-linking agent comprises adding 5.3 parts by weight of 40% butyl 4,4-di(tert-butylperoxy)valerate powder on calcium carbonate and silica; and, additionally comprising steps, performed prior to said step of adding a cross-linking agent, of (a) adding 1.2 parts by weight polyethylene; (b) adding 0.6 parts by weight ZnO; (c) adding 1.2 parts by weight MgO; (d) adding 12.0 parts by weight carbon black; and (a) adding 3.5 parts by weight TMPTMA.

It is a further object of this invention to disclose an elastomeric material prepared according any of the methods disclosed above, including any combination of different precursors and/or elastomeric materials as defined in any of the above.

It is a further object of this invention to disclose the use of the precursor and/or elastomeric material as defined in any of the above, including any combination of different precursors and/or elastomeric materials as defined in any of the above, in at least one of the following: roofing material; sealing material; an automotive component (in some embodiments, said automotive component is selected from the group consisting of as door seals and shock absorbers); a material for flexographic or gravure printing; a medical device; protective clothing; concertina bellows for buses or trains; an inflatable product.

It is a further object of this invention to disclose the use of the precursor and/or elastomeric material as defined in any of the above, including any combination of different precursors and/or elastomeric materials as defined in any of the above, in a microfluidic device.

It is a further object of this invention to disclose the use of the precursor and/or elastomeric material as defined in any of the above, including any combination of different precursors and/or elastomeric materials as defined in any of the above, in a phase change material.

It is a further object of this invention to disclose the use of the precursor and/or elastomeric material as defined in any of the above, including any combination of different precursors and/or elastomeric materials as defined in any of the above, in a membrane or diaphragm.

It is a further object of this invention to disclose a microfluidic device made from the precursor and/or elastomeric material as defined in any of the above, including any combination of different precursors and/or elastomeric materials as defined in any of the above. In some embodiments of the invention, the microfluidic device is selected from the group consisting of devices for pumping a fluid flow; devices for valving a fluid flow; devices for mixing reagents; devices for separating different chemical and/or particle species; devices for concentrating different chemical and/or particle species; devices for detecting different chemical and/or particle species; and devices configured to perform any combination of the above. In some embodiments of the invention, the microfluidic device is produced by laser engraving.

It is a further object of this invention to disclose a phase change material comprising the precursor and/or elastomeric material as defined in any of the above, including any combination of different precursors and/or elastomeric materials as defined in any of the above. In some embodiments of the invention, the working temperature of the phase change material is between 120° C. and 280° C.

It is a further object of this invention to disclose a cell 100 for a thermal energy storage system, wherein said cell comprises at least one heat exchange unit 101 in thermal contact with said cell; phase change material 102 comprising the precursor and/or elastomeric material as defined in any of the above (including any combination of different precursors and/or elastomeric materials as defined in any of the above), located within said cell and in thermal contact with said heat exchange unit; a heat conductive rubber matrix 103 located within said cell; and rubber microparticles 104 located within said cell.

### BRIEF DESCRIPTION OF THE DRAWINGS

The invention will now be described with reference to the drawings, wherein:

FIG. 1 presents schematic illustrations of uses of the precursor herein disclosed in microfluidic and phase changing materials (PCMs) applications. FIG. 1A presents a schematic illustration of a microfluidic concentrator and separator made from the precursor material disclosed herein; FIG. 1B presents a schematic illustration of a multilayer microfludic pillar array; FIG. 1C presents a 9 cm×2 cm polymeric cover; FIG. 1D presents an engraving plate for producing the device shown in FIG. 1C. The plate is placed in a CO₂ laser engraving machine. The engraving conditions were 100.00 points/mm; 5.00 μm/sec; height 0.20 mm; NM 10/4; power 300 W; pillar diameter 80 μm; pillar height 200 μm; space between pillars 90 μm; the total number of pillars was 24000 (3000 per cm²); FIG. 1E presents a schematic diagram of the use and function of a PCM in a solar energy storage system; and FIG. 1F presents a schematic illustration of a PCM system 100 that uses the materials of the current disclosure. The energy storage system illustrated in the figure is composed of heat exchange elements that are enclosed in a PCM matrix;

FIG. 2 presents results of TGA analyses of samples of elastomers prepared from a precursor according to one embodiment of the invention disclosed herein;

FIG. 3 presents results of DSC analyses of samples of elastomers prepared from a precursor according to one embodiment of the invention disclosed herein. FIG. 3A presents results for B2-1 sample (table 1); FIG. 3B presents results for repeated experiment with the B2-1 sample having a different mass compared to FIG. 3A; and FIG. 3C presents results for B2-3 sample (table 1);

FIG. 4 presents results of DSC analyses of individual components of the compositions herein disclosed. FIG. 4A presents a DSC analysis of ppEDM; FIG. 4B presents a DSC analysis of a composition comprising EPDM and a cross-linking agent, but no TPV; and FIG. 4C presents a DSC analysis of a composition comprising EPDM, carbon black, and a cross-linking agent, but no TPV;

FIG. 5 presents results of DSC analyses of several embodiments of the precursor herein disclosed (table 6). FIG. 5A presents results of M01-1; FIG. 5B presents results of M02-1; FIG. 5C presents results of M05-1; FIG. 5D presents results of M06-1; FIG. 5E presents results of M07-1; and FIG. 5F presents results of M10-1;

FIG. 6 presents results of DSC analyses of a number of compositions based on NBR (table 7). FIG. 6A presents results of NBR2-6; FIG. 6B presents results of NBR2-8; FIG. 6C presents results of NBR2-11; and FIG. 6D presents results of NBR2-13; and,

FIG. 7 presents the results of a TGA analysis of a typical rubber composition known in the art that contains a silica filler.

### DETAILED DESCRIPTION OF THE PREFERRED EMBODIMENTS

In the following description, various aspects of the invention will be described. For the purposes of explanation, specific details are set forth in order to provide a thorough understanding of the invention. It will be apparent to one skilled in the art that there are other embodiments of the invention that differ in details without affecting the essential nature thereof. Therefore the invention is not limited by that which is illustrated in the figures and described in the specification and examples, but only as indicated in the accompanying claims, with the proper scope determined only by the broadest interpretation of said claims.

As used herein, the term “cross-linking” refers to any process that bonds chains of a polymer one to another. “Vulcanization” of rubber is thus one example of “cross-linking” as the term is used herein.

The inventors have found that the properties of a wide range of rubbers can be beneficially modified by inclusion of thermoplastic vulcanizates (TPVs) and/or thermoplastics into which microparticles of rubber (which may be recycled rubber) have been incorporated. Non-limiting examples of rubber useful for the present invention include natural rubber (NR), nitrile butadiene rubber (NBR), hydrogenated nitrile butadiene rubber (HNBR), carboxylated nitrile rubber (XNBR), butyl rubber (IIR), chlorobutyl rubber (CIIR), bromobutyl rubber (BIIR), polychloroprene (CR), styrene-butadiene rubber (SBR), polybutadiene (BR), ethylene-propylene-diene tripolymer (EPDM), ethylene-propylene rubber (EPM), silicone rubber, polyurethane rubber (PU), acrylic rubber (ACM), ethylene vinylacetate copolymer rubber (EVM), and mixtures thereof.

Non-limiting examples of TPVs that have been found useful for modifying the properties of the rubber include polypropylene-EPDM blends (ppEPDM), silicone-thermoplastic blends such as commercially available TPSiV™ (Dow), and styrene-based TPVs such as commercially available MULTIFLEX® (Dow), poly(styrene-butadiene-styrene) (SBS), styrene isoprene butadiene (SIBS), acrylonitrile butadiene styrene (ABS), styrene-ethylene-butylene-styrene copolymer (SEBS), polyethylene/EPDM (peEPDM), polyethylene/EPM (peEPM), polyurethane(PU), polyamide/acrylic rubber (paACM), and thermoplastic polyester elastomer/ethylene-vinylacetate copolymer rubber (tpc-etEVM).

Rubber/TPV formulations have significantly reduced swelling and leaching relative to formulations based on one or the other of the materials. Since, in preferred embodiments, inorganic material accounts for no more than a few percent of the total weight of the material, these formulations are significantly cleaner than many materials used in typical applications for elastomeric materials, such as in flexo plate printing in laser-engraved microfluidic devices. Additional advantages of the rubber/TPV formulations of the present invention for printing applications include faster ablation relative to formulations known in the prior art, and fewer shadows during printing due to the materials greater stiffness. In addition, the physical properties of the final product can be controlled by the level of cross-linking, which can be controlled by the amount of cross-linking agent added or the cross-linking conditions.

It is thus within the scope of the invention to provide a precursor to such an elastomer composition. In some embodiments of the invention the precursor comprises cross-linkable rubber, at least one TPV, and at least one cross-linking agent. In preferred embodiments of the invention, the rubber and TPV are chosen from the materials given above. In preferred embodiments, the weight ratio of the rubber to the TPV is between 90:10 and 10:90. In more preferred embodiments, the weight ratio of the rubber to the TPV is between 70:30 and 30:70. The Durometer hardness of the elastomer depends inter alia on the rubber:TPV ratio; thus, the specific ratio used in a given sample of precursor will depend on the desired properties of the final elastomer product. The properties of the elastomer product derived from the precursor of the present invention can thus be fine-tuned to suit the needs of the particular application (see Example 5 below).

The cross-linking agent may be any appropriate agent known in the art. Non-limiting examples of suitable cross-linking agents include sulfur, peroxides, phenolic resins, amines, and acrylates.

The cross linking co-agent may be any appropriate agent known in the art. Non-limiting examples of sulfur donor cross-linking agents include dithiocarbamates, thiurams, thiazoles, guanidines, and sulfenamides.

In the most preferred embodiments of the invention, however, peroxide cross-linking agents are used, as these materials can react with single carbon-carbon bonds and thus produce a higher curing density and better compression set. Compression set is especially important in printing applications because it represents the resistance to changes in printing by the plate being impacted on each printing impression followed by a brief recovery between printing. In addition, some peroxide agents produce less odor during the cross-linking than do sulfur cross-linking agents. Non-limiting examples of peroxide cross-linking agents that have been found useful in the present invention include butyl-4,4-di(tert-butylperoxy)valerate; di(tert-butyl) peroxide; di(tert-butylperoxyisopropyl)benzene; dicumyl peroxide; 2,5-dimethyl-2,5-bis-(tert-butylperoxy)hexane. Non-limiting examples of cross-linking co-agents that can be utilized with peroxides include BMI-MP, EDMA, 1,2-BR, DATP, DVB, TAC, TAIC, and TAP. The cross-linking agent may be supported on granules of inert material such as silica. Since the physical properties of the final elastomer product depend on the level of cross-linking, the amount of cross-linking agent added to the precursor will depend on the specific application. In typical embodiments, the amount of cross-linking agent is on the order of 5% by weight relative to the total weight of rubber and TPV.

The final elastomeric product produced by curing the precursor need not be fully cross-linked. Thus, in some embodiments of the invention, the final elastomeric product is substantially fully cross-linked, while in others, it is only partially cross-linked.

In some embodiments of the invention, the precursor also comprises a cross-linking co-agent. The cross-linking co-agent may be any such agent known in the art. In some embodiments of the invention, the cross-linking co-agent comprises scrylate, a triazine, or 1,8-diazabicyclo-5,4,0-undec-7-ene (DBU) with saturated dibasic acids. In preferred embodiments of the invention, acrylate cross-linking co-agents are used. A non-limiting example of a suitable cross-linking co-agent is trimethyl-ol-propane-trimethylacrylate (TMPTMA).

In some embodiments of the invention, the precursor also comprises a filler. In some embodiments, the precursor comprises between 1% and 70% by weight of filler. The filler may be any appropriate material known in the art. Non-limiting examples of fillers that can be used with the precursor of the present invention include silica, mica, kaolin, clay, coal dust, lignin, talc, BaSO₄, CaCO₃, Al(OH)₃, Mg(OH)₂, ZnO, and MgO.

In some embodiments of the invention, the precursor additionally contains carbon black. Typically, in those embodiments in which carbon black is included, the precursor comprises between 1% and 60% carbon black by weight. In preferred embodiments in which carbon black is included, the precursor comprises between 5% and 35% carbon black by weight.

In preferred embodiments of the invention, the total weight of additives other than rubber and TPV does not exceed the total weight of rubber and TPV. The inventors have found that addition of excessive amounts of additives leads to excessive compound hardness and unacceptably low elasticity and elongation.

In some embodiments, the precursor contains a plasticizer. Any plasticizer known in the art that is appropriate for use with rubber and TPV and that is compatible with the rubber(s) and TPV(s) used may be used.

In other embodiments, the precursor is free of plasticizers such as mineral oil. Indeed, the inventors have found that for some applications, such additives can actually reduce the quality of the precursor or final elastomer product, as they tend to come to the surface during grinding and thus block the grinding medium. They also give compounds that may swell or lose material and may sweat out during long term storage. In many applications, the precursor is bonded to a polyester film, to a fabric, or to a metal. Sweating of plasticizer can reduce the adhesion between the rubber layer and the supporting layer causing debonding during use. In addition, plasticizers can reduce the effectiveness of the residual thermoplasticity of the composition.

It is also within the scope of the invention to disclose an elastomer composition, produced from the precursor by cross-linking. In some embodiments, the TPV is cross-linked either internally or to the polymer chains of the rubber. The cross-linking may be accomplished by any method known in the art. In preferred embodiments, the cross-linking is initiated either by heating or by irradiation with UV light.

The elastomers of the present invention can be used in any application in which a thermoplastic or rubber would be used. Non-limiting examples of such applications include roofing, sealing, automotive components such as door seals and shock absorbers, flexographic or gravure printing, medical devices, protective clothing, concertina bellows for buses or trains, inflatable products, membranes, diaphragms, etc.

The elastomers of the present invention can also be produced as a coating on a continuous roll of fabric. In some embodiments, the precursor mixture is mixed onto a fabric base while being fed through a calendar. In other embodiments, the mixture is dissolved in a suitable solvent. A continuous roll of material can then be produced from the solution by methods well-known in the art such as spread-coating or by dipping the fabric in the solution.

It is also within the scope of the invention to disclose a method for making a precursor for an elastomer material. The method comprises method comprises (a) mixing rubber and at least one material selected from the group consisting of TPV, thermoplastic incorporating microparticles of rubber and any combination thereof; and (b) adding at least one cross-linking agent. In some embodiments of the method, it also comprises a step of adding a cross-linking co-agent. In some embodiments of the method, it also comprises one or more steps of adding additional components such as carbon black, polymers, or inorganic fillers such as silica, mica, kaolin, clay, coal dust, lignin, talc, BaSO₄, CaCO₃, Al(OH)₃, Mg(OH)₂, ZnO, or MgO.

In some embodiments of the method, the mixing is performed in an apparatus such as an internal mixer or an extruder. In preferred embodiments, the operating temperature of the apparatus is above the melting point of the thermoplastic component (typical operating temperatures are 150-270° C.). In preferred embodiments of the invention, the mixing continues at least until a homogeneous mixture is obtained. In some embodiments of the invention, the mixing continues until a constant stress reading is obtained in the mixer.

The addition of cross-linking agent is performed only after the mixing is completed. In typical embodiments, the cross-linking agent are added after the mixture of other ingredients is removed from the apparatus in which mixing is performed. The inventors have found that the properties of the final elastomeric product are not very sensitive to the details of the mixing step, except that the addition of the cross-linking agent must be performed subsequent to the initial mixing of rubber and thermoplastic material. Normally, this step is performed after all other ingredients have been mixed, but the cross-linking agent and co-agent can be added with other fillers after the initial mixing of rubber and thermoplastic material.

In some embodiments of the invention, the method includes additional steps of introducing the material extracted from the mixer into a mill, preferably a two roller mill, and milling the material. In preferred embodiments, the addition of cross-linking agent (and cross-linking co-agent in those embodiments that include this step) occurs concomitant with the introduction of the material into the mill

It is also within the scope of the invention to disclose a method for making an elastomeric material that comprises rubber into which a TPV has been incorporated. The method comprises preparing a precursor according to any of the embodiments disclosed above, and cross-linking the cross-linkable rubber. The cross-linking may be initiated by any method known in the art. Non-limiting examples include heating and irradiating with UV light. In some embodiments, the method additionally comprises a step of cross-linking the TPV, either internally or to the rubber.

It is also within the scope of the invention to disclose an elastomer composition comprising rubber and TPV that is the product of the method disclosed above. The properties of the elastomer composition (hardness, elasticity, etc.) can be tuned by appropriate choice of the rubber:TPV ratio and the amount and type of cross-linking agent in the precursor, and the extent of cross-linking in the elastomer itself.

It is within the scope of the invention to disclose the use of the precursor material in microfluidic devices and systems. Non-limiting examples of methods by which microfluidic devices and systems made from the materials herein disclosed can be fabricated include replica and injection molding, embossing, and laser ablation. Non-limiting examples of on-chip operations that have been implemented on microfluidic devices and systems made from these materials include pumping and valving of fluid flow, reagent mixing, and separation, concentration, detection of different chemical and particle species.

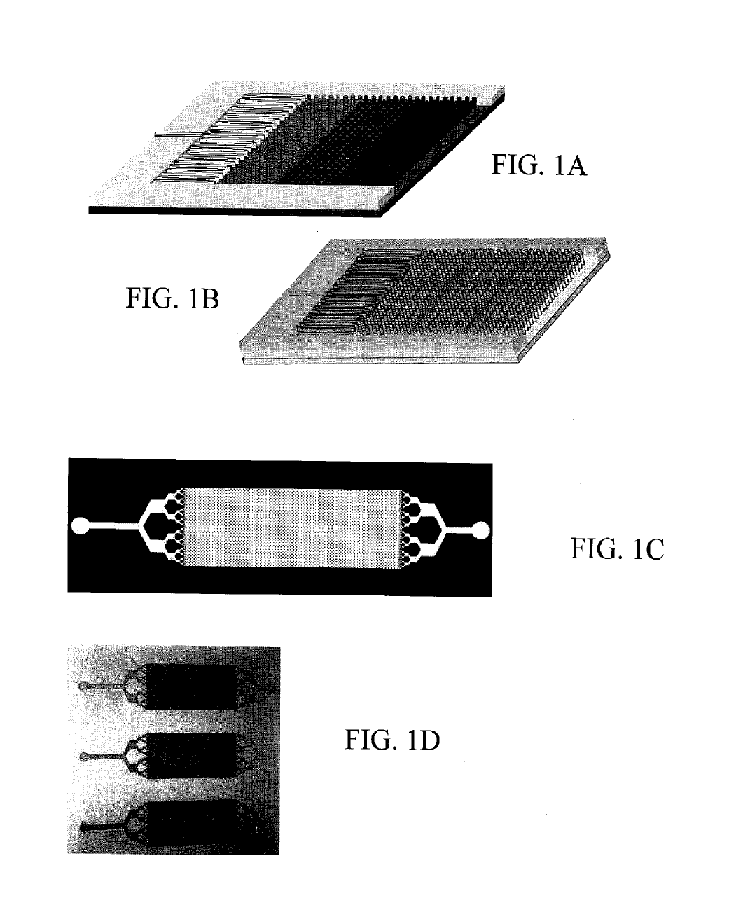

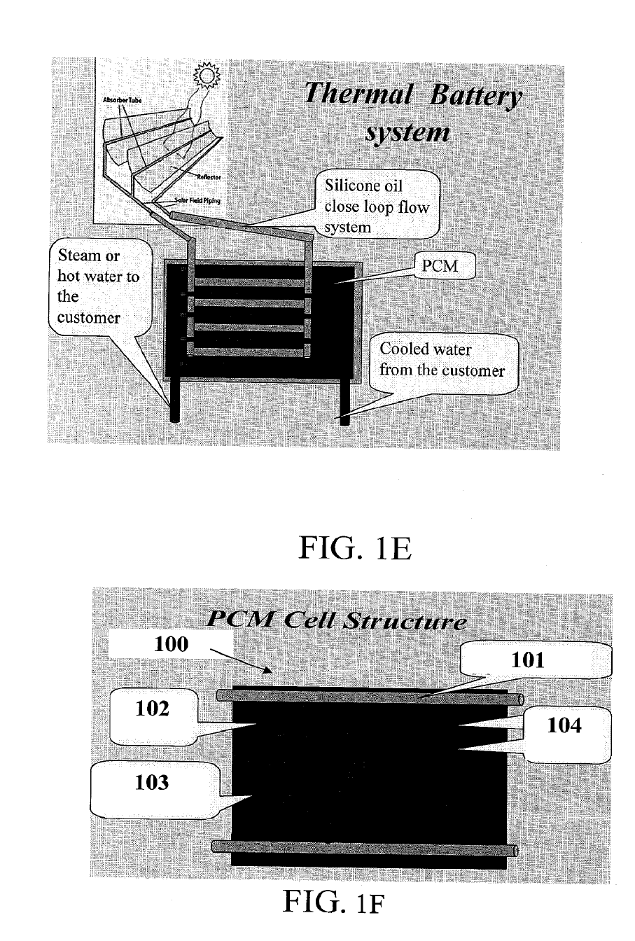

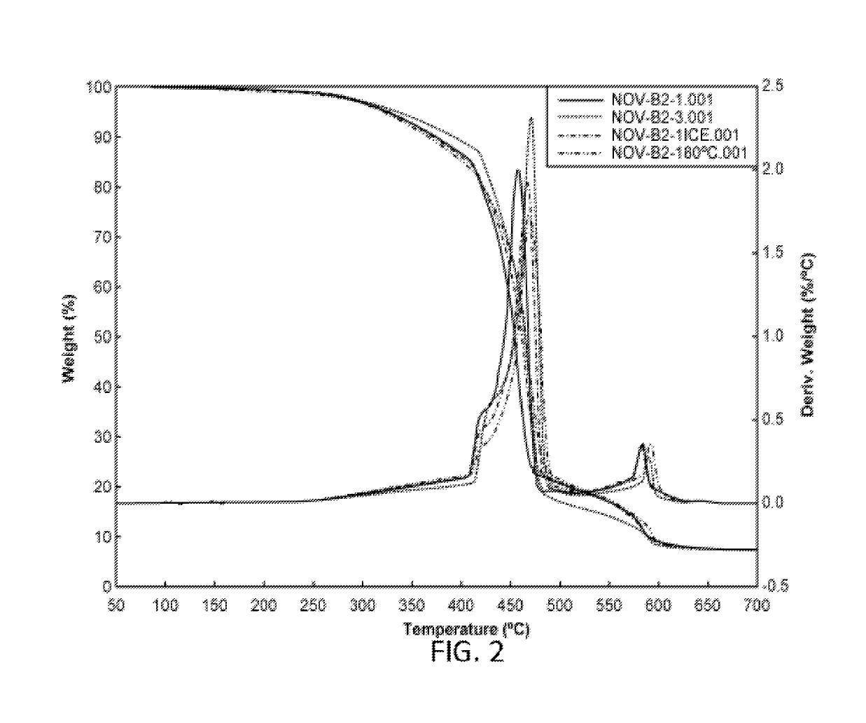

Reference is now made to FIG. 1, which presents schematic illustrations of a number of non-limiting embodiments of microfluidic devices constructed from the materials of the present invention. FIG. 1A presents a schematic illustration of a microfluidic concentrator and separator made from the precursor material disclosed herein. FIG. 1B presents a schematic illustration of a multilayer microfludic pillar array.

In investigations of the reaction of the polymeric material with a laser engraving machine, the inventors have found that the optimum coverage of the polymer is about 35% (a range of 30%-50% was investigated). FIG. 1C illustrates a 9 cm×2 cm cover.

FIG. 1D illustrates an engraving plate for producing the device shown in FIG. 1C. The plate is placed in a CO₂ laser engraving machine. The engraving conditions were 100.00 points/mm; 5.00 μm/sec; height 0.20 mm; NM 10/4; power 300 W; pillar diameter 80 μm; pillar height 200 μm; space between pillars 90 μm; the total number of pillars was 24000 (3000 per cm²).

It is also within the scope of the invention to disclose the use of the precursors herein disclosed as phase change materials. “Phase change materials” (PCMs) are materials that have a high heat of fusion, and hence can store or release large amounts of energy when they undergo a phase change such as melting or solidifying.

One non-limiting example of a use of the materials herein disclosed is as a PCM in a solar energy storage system. Reference is now made to FIG. 1E, which presents a schematic diagram of the use and function of a PCM in such a system. “Low temperature” solar energy storage systems use materials such as water or paraffin to store solar thermal energy. These systems are relatively inexpensive, but of very low efficiency, and are used mostly in hot water and air conditioning systems. “High temperature” systems have higher energy efficiency, and can be used for electricity and steam production, but tend to be more complicated and expensive. The materials herein disclosed provide an efficient and economical solution in the intermediate temperature region (about 120° C.-280° C.).

Reference is now made to FIG. 1F, which presents a schematic illustration of a PCM system 100 that uses the materials of the current disclosure. The energy storage system illustrated in the figure is composed of heat exchange elements that are enclosed in a PCM matrix. The form in which the material is packaged minimizes the effect of the “Stefan problem” (the problem of the transfer of heat in a system undergoing a phase transition). A typical PCM cell, such as that shown in the illustration, comprises four basic structural elements: heat exchange units (e.g. pipes) 101, for transferring energy from the cell to the environments; rubber-like microparticles 104 located within the cell; a matrix 102 of thermoplastic material of the present invention; and a rubber-like matrix 103. The chemistry of matrix 103 can be adjusted to the target working temperature.

The thermoplastic material 102 undergoes a phase change (storage or release of latent heat) during the process of energy consumption or release. The other structural elements of the system do not move; thus, the heating/cooling cycle does not change the size or shape of cell 100. Rubber-like matrix 103 does not undergo a phase transfer, and its only contribution to the storage or release of energy is via sensible heat (as opposed to the latent heat contribution of PCM 102). This design optimizes heat transfer in the system.

### EXAMPLES

The following examples present typical embodiments of the precursor herein disclosed and of methods for its preparation. The examples are presented to illustrate the preparation, properties, and uses of the compositions disclosed herein, and are not in any way to be taken as limiting the scope of the invention as claimed. In the tables given in the examples, the numbers represent the relative amounts by weight of the components of the composition.

### Example 1

60 parts by weight of EPDM rubber (ROYALENE 525 grade) were combined with 40 parts by weight of ppEPDM (FORPRENE, obtained from So.f.ter SPA) in a Banbury mixer operating between 190 and 200° C. During the mixing, the following ingredients were added: polyethylene AC6 (1.2 parts by weight); ZnO (0.6 parts by weight); carbon black (12.0 parts by weight); and MgO (1.2 parts by weight).

The entire mixture was mixed until the mixer provided a constant stress reading (approximately 5 minutes of additional mixing). The resulting mixture was removed from the mixer as a homogeneous mass. The mass was then masticated in a “Vals” two roller mill along with 3.5 parts by weight of TMPTMA70 and 5.3 parts by weight of peroxide crosslinking agent (TRIGONOX 17-40B Butyl 4,4-di(tert-butylperoxy)valerate or LUPEROX DC40 dicumyl peroxide). Mastication continued until the material formed into a sheet. The Mooney viscosity of the mixture was 142.2 at 100° C.

### Example 2

An elastomeric composition was produced from the precursor formed in Example 1. The sheet removed from the mill was fed, along with a fabric base, through a calendar at a temperature of ˜80° C. and then fed into an autoclave at 150° C. The resulting sheet was then laminated onto a 75 μm PET film and then post-cured in an autoclave at 120° C.

### Example 3

Elastomeric compositions were made by cross-linking of precursors made according to the present invention. The compositions were placed for 40 min in a pneumatic press at 165° C. and 8 atm pressure, and the tensile strength measured. The tensile strength of the compositions of the present invention was typically in the range of 13.7-15.7 MPa (140-160 kg cm⁻²). The tensile strengths of a composition containing all of the components of the present invention except for TPV and of EPDM were measured and found to be about 11 MPa (112-115 kg cm⁻²). The results of this experiment demonstrate that the present compositions have higher tensile strengths than those of the components from which they are made.

### Example 4

Calorimetric measurements were made of elastomeric compositions produced by cross-linking of precursors made according to the present invention. The compositions of the precursors are given in Table 1.

TABLE 1

Sample Number

| | B2-1 | B2-3 |
|---|---|---|
| Component | | |
| EDPM | 100 g | 100 g |
| ppEPDM | 70 g | 40.18 g |
| carbon black | 20 g | 11.48 g |
| Polyethylene AC6 | 2 g | 2 g |
| ZnO | 1 g | 1 g |
| MgO | 2 g | 2 g |
| TMPTMA70 | 6 g | 6 g |
| crosslinking agent | 9 g | 9 g |
| (TRIGONOX 17-40B) | | |
| Property | | |
| Mooney Viscosity, 100° C. | 142.2 | 100.1 |
| Mooney Viscosity, 100° C. | 62.0 | 44.0 |

Reference is now made to FIG. 2, which shows results of thermogravimetric analyses (TGA) of four samples of elastomers made by cross-linking of the precursors listed in Table 1. The decomposition proceeds in two steps; the lower-temperature decomposition (derivative peak at ˜450° C.) indicates decomposition of the rubber/TPV component, while the higher-temperature decomposition (derivative peak at 550-600° C.) indicates decomposition of the carbon black component. Noteworthy is that after the decomposition is complete, only ˜3% of the original weight remains. This result is in contrast to typical rubber compositions, in which ˜30% of the original material remains after decomposition.

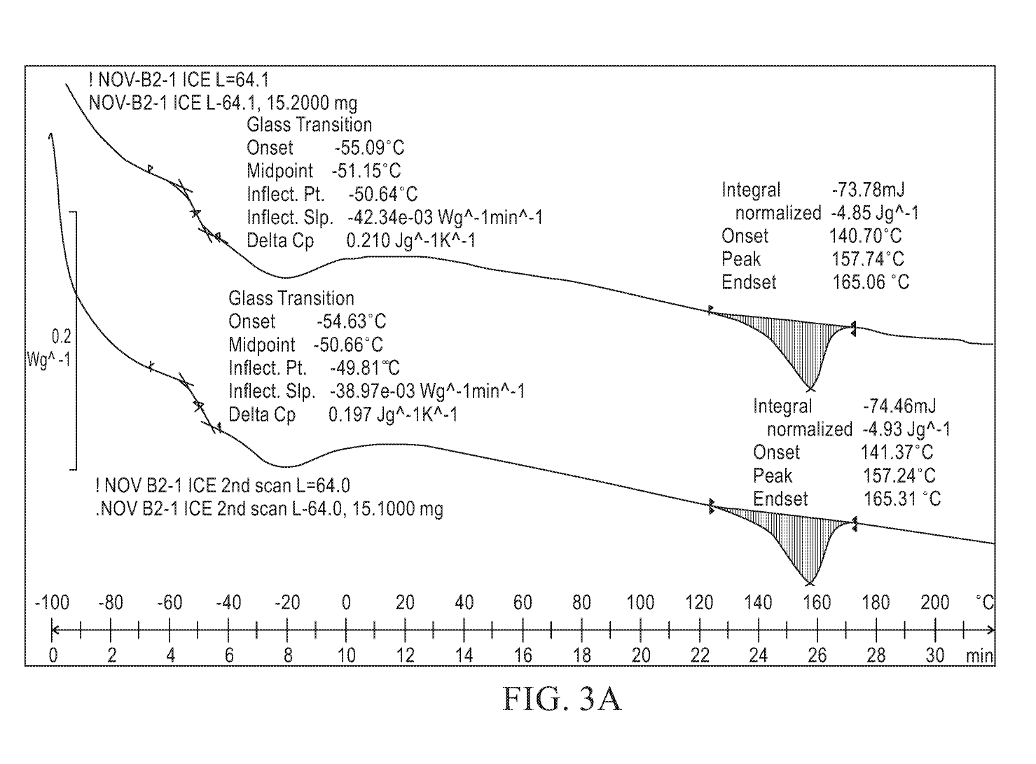

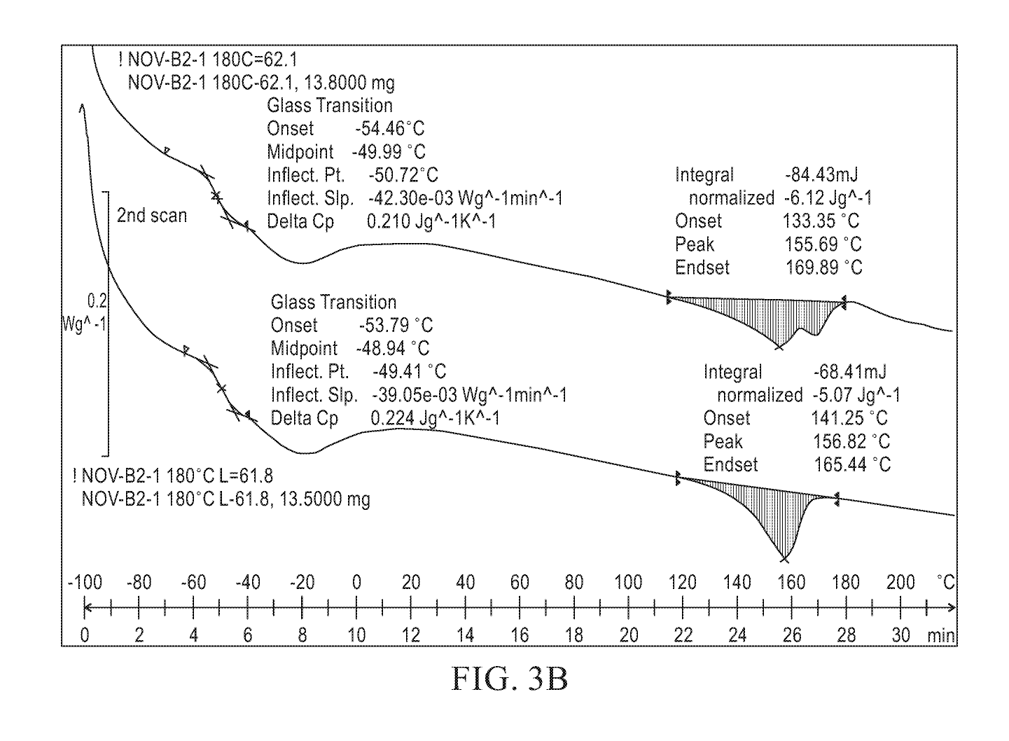

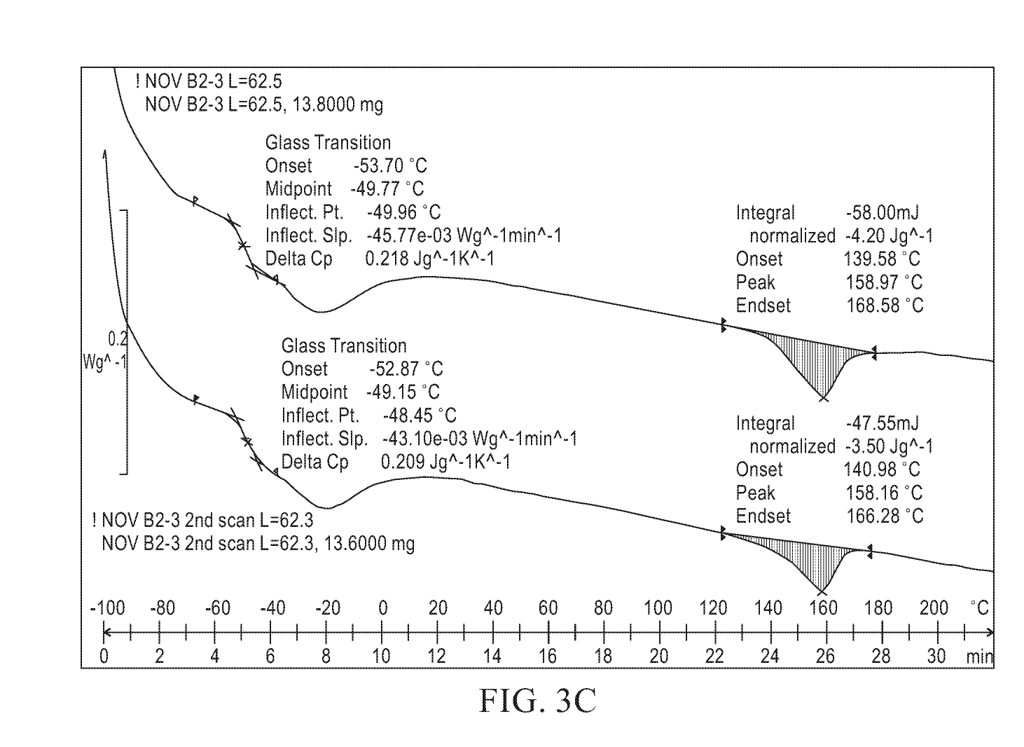

Reference is now made to FIGS. 3A-3C, which show a series of differential scanning calorimetry (DSC) analyses of samples of an elastomer made by cross-linking of the precursors listed in Table 1; results for sample “B2-1” are shown in FIGS. 3A and 3B, while results for sample “B2-3” are shown in FIG. 3C. The DSC results demonstrate that, unlike typical rubber compositions known in the art, elastomers produced from the precursor disclosed herein show a single definite melting point.

### Example 5

As was disclosed above, the physical properties of the precursor of the present invention can be fine-tuned by appropriate choice of the relative amounts of the components, particularly the rubber and TPV. A series of compositions was prepared, and the Shore A hardness of the compositions was measured in a pneumatic press at 165° C. (40 min, 8 atm) and at 220° C. (20 min, 4 atm). The results are summarized in Table 2.

TABLE 2

| | Sample No. | | | | | | | | | | | | | |
|---|---|---|---|---|---|---|---|---|---|---|---|---|---|---|
| Component | B3′ | | B3-1 | | B3-2 | | B2′ | | B2-1 | | B2-2 | | B2-3 | |
| EPDM | 100 | g | 100 | g | 100 | g | 100 | g | 100 | g | 100 | g | 100 | g |
| ppEPDM | 50.1 | g | 70 | g | 60.06 | g | 50.1 | g | 70 | g | 60.06 | g | 40.18 | g |
| Carbon black | 14.31 | g | 20 | g | 17.16 | g | 14.31 | g | 20 | g | 17.16 | g | 11.48 | g |
| Polyethylene AC6 | 2 | g | 2 | g | 2 | g | 2 | g | 2 | g | 2 | g | 2 | g |
| ZnO | 1 | g | 1 | g | 1 | g | 1 | g | 1 | g | 1 | g | 1 | g |
| MgO | 2 | g | 2 | g | 2 | g | 2 | g | 2 | g | 2 | g | 2 | g |
| TMPTMA70 | 6 | g | 6 | g | 6 | g | 6 | g | 6 | g | 6 | g | 6 | g |
| crosslinking agent | — | | — | | — | | 9 | g | 9 | g | 9 | g | 9 | g |
| (TRIGONOX 17-40B) | | | | | | | | | | | | | | |
| crosslinking agent | 9 | g | 9 | g | 9 | g | — | | — | | — | | — | |
| (LUPEROX DC40) | | | | | | | | | | | | | | |

| | Sample No. | | | | | | |
|---|---|---|---|---|---|---|---|
| Property | B3′ | B3-1 | B3-2 | B2′ | B2-1 | B2-2 | B2-3 |
| Shore Hardness A | 70.6 | 75.1 | 72.7 | 72.2 | 75.2 | 74.7 | 70.6 |
| vulc. at 165° C. | | | | | | | |
| Shore Hardness A | 66.6 | 71.9 | 67.4 | 69.7 | 71.9 | 71.0 | 68.5 |
| vulc. at 220° C. | | | | | | | |

### Example 6

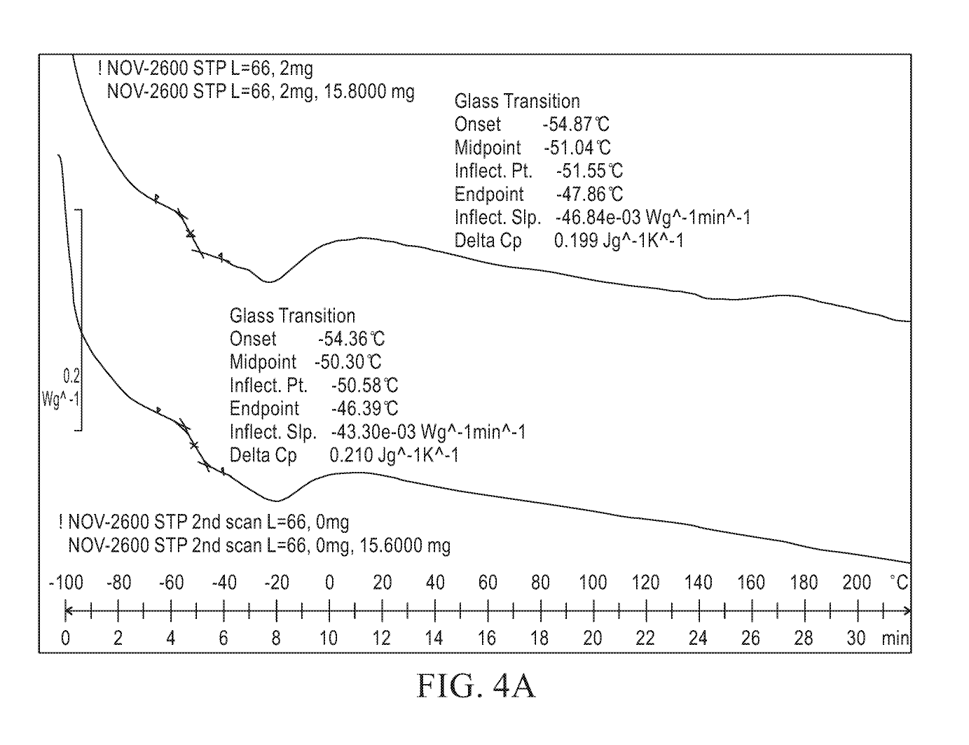

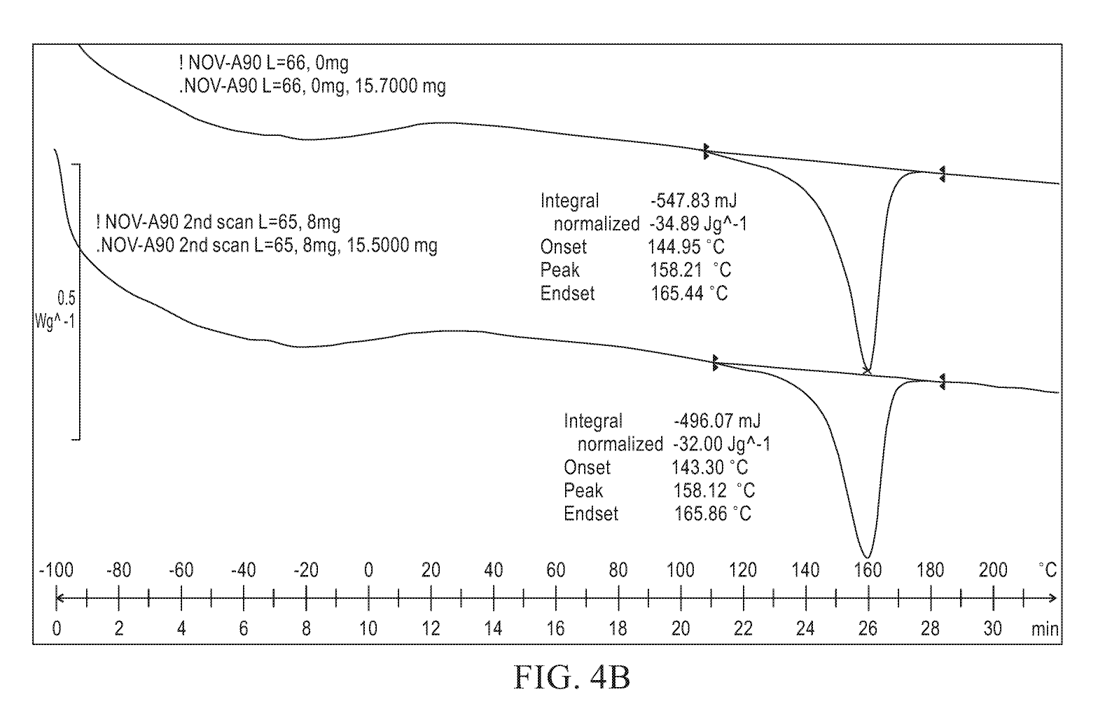

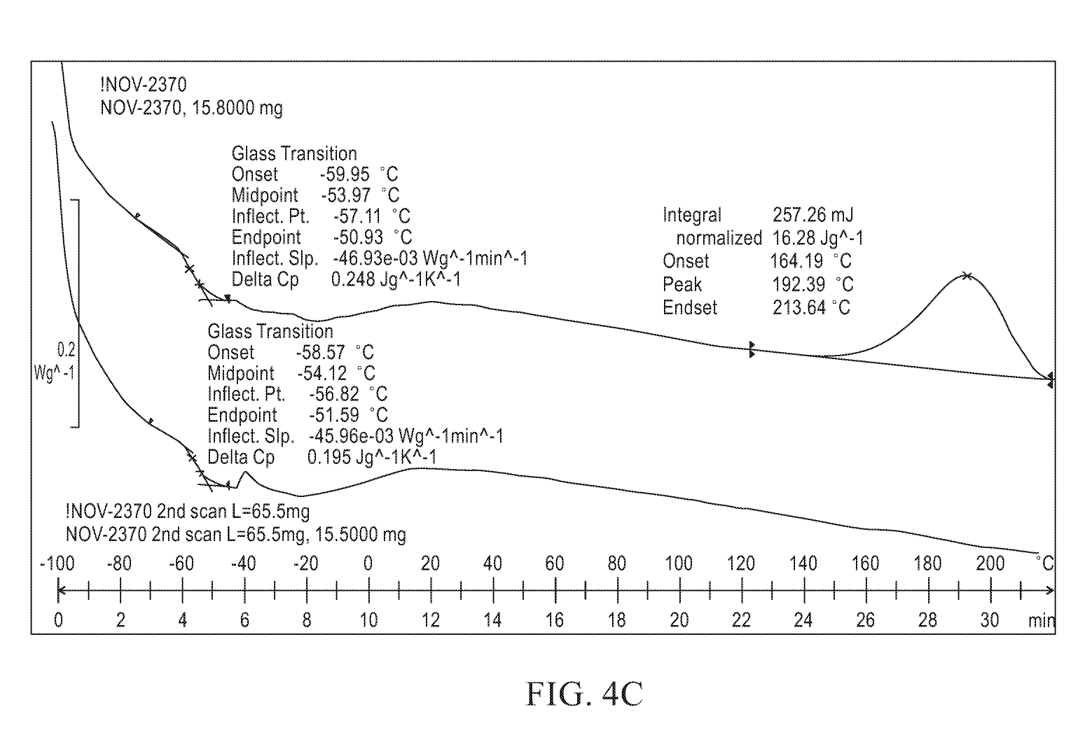

Calorimetric analyses were performed of a series of compositions in which each composition was lacking at least one component of the compositions of the present invention. Reference is now made to FIG. 4A, which presents a DSC analysis of ppEDM; FIG. 4B, which presents a DSC analysis of a composition of a composition comprising EPDM and a cross-linking agent, but no TPV; and FIG. 4C, which presents a DSC analysis of a composition comprising EPDM, carbon black, and a cross-linking agent, but no TPV. As can be seen by comparison of the DSC results shown in FIG. 4 to those shown in FIG. 3, the low-temperature thermal behavior of the compositions of the current invention is comparable to that of rubber (or rubber containing similar fillers), while the high-temperature behavior is comparable to that of TPV. Furthermore, the compositions of the present invention do not show an externally visible melt at high temperature. That is, the improved physical properties do not come at the expense of any noticeable change in the thermal properties.

### Example 7

The effects of changing the type and amount of filler on the properties of the composition were investigated. Relevant physical properties of some exemplary compositions are summarized in Table 3.

TABLE 3

| | Sample No. | | | | |
|---|---|---|---|---|---|
| | MN10-5 | MN10-1 | MN10-2 | MNC1-1 | MNC1-2 |
| Component | | | | | |
| EPDM | 100 g | 100 g | 100 g | 100 g | 100 g |
| ppEPDM | 100 g | 100 g | 100 g | 70 g | 70 g |
| Carbon black | | 20 g | 40 g | | |
| Silica | | | | | 20 g |
| Polyethylene AC6 | 2 g | 2 g | 2 g | 2 g | 2 g |
| ZnO | 1 g | 1 g | 1 g | 1 g | 1 g |
| MgO | 2 g | 2 g | 2 g | 2 g | 2 g |
| TMPTMA70 | 4.6 g | 6 g | 6 g | 6 g | 6 g |
| crosslinking agent | 7 g | 9 g | 9 g | 9 g | 9 g |
| (TRIGONOX 17-40B) | | | | | |
| Property | | | | | |
| Shore Hardness A | 67.7 | 81.3 | 89.2 | 63.4 | 70.5 |
| vulc. at 165° C. | | | | | |
| Tensile Strength | 8.93 | 14.12 | 18.37 | 6.15 | 11.32 |
| MPa LONG. | | | | | |
| Elongation at break (%) | 221.0 | 128.0 | 52.0 | 200.0 | 313.0 |
| Abrasion TABER (mg) | 0.006 | 0.018 | 0.039 | 0.039 | 0.080 |

As can be seen from the results summarized in the table, both carbon black and silica improve the physical properties of the material. When silica is used as the filer, however, the precursor has a lower resistance to abrasion in comparison to a precursor that is identical except for the use of carbon black as the filler. In addition, the surface of the rubber is rougher when silica is used as the filler. The use of TPV as a filler improves both the surface roughness during ablation and the abrasion resistance.

### Example 8

The effects of addition of different amounts of carbon black on the physical properties of the resulting composition were investigated. Results are summarized in Table 4.

TABLE 4

| | Sample No. | | | | |
|---|---|---|---|---|---|
| | MN10-1 | MN10-2 | MN10-3 | MN10-4 | MN10-5 |
| Component | | | | | |
| EPDM | 100 g | 100 g | 100 g | 100 g | 100 g |
| ppEPDM | 100 g | 100 g | 100 g | 100 g | 100 g |
| Carbon black | 20 g | 40 g | 30 g | 35 g | 0 g |
| Polyethylene AC6 | 2 g | 2 g | 2 g | 2 g | 2 g |
| ZnO | 1 g | 1 g | 1 g | 1 g | 1 g |
| MgO | 2 g | 2 g | 2 g | 2 g | 2 g |
| TMPTMA70 | 6 g | 6 g | 4.6 g | 4.6 g | 4.6 g |
| crosslinking agent | 9 g | 9 g | 7 g | 7 g | 7 g |
| (TRIGONOX 17-40B) | | | | | |
| Property | | | | | |
| Shore Hardness A | 81.3 | 89.2 | 81.6 | 83.6 | 67.7 |
| vulc. at 165° C. | | | | | |
| Tensile Strength | 14.12 | 18.37 | 14.71 | 13.18 | 8.93 |
| MPa LONG. | | | | | |
| Elongation at break (%) | 128.0 | 52.0 | 131.0 | 99.2 | 221.0 |
| Abrasion TABER (mg) | 0.018 | 0.039 | 0.012 | 0.011 | 0.006 |
| Resistance Ω | >400 | 82 | 200 | 100 | >40G |

As expected, addition of conductive carbon black to the EPDM-TV matrix lowers the electrical resistance. While addition of carbon black also increases the strength and hardness of the precursor, it also reduces the elongation at break of the rubber.

### Example 9

The effect of changing the EPDM used in the precursor was investigated. Typical results are summarized in Table 5.

TABLE 5

| | | Sample No. | | | | | |
|---|---|---|---|---|---|---|---|
| | Component | MN10-4 | MN11-01 | MN12-01 | MN13-01 | MN14-01 | MN19-01 |
| EPDM | ROYALENE 525 | 100 g | | | | | 100 g |
| | VISTALON 404 | | 100 g | | | | |
| | VISTALON 706 | | | 100 g | | | |
| | KEP 110 | | | | 100 g | | |
| | KEPA 1130 | | | | | 100 g | |
| | ppEPDM | 100 g | 100 g | 100 g | 100 g | 100 g | |
| | Carbon black | 35 g | 35 g | 35 g | 35 g | 35 g | 35 g |
| | Polyethylene AC6 | 2 g | 2 g | 2 g | 2 g | 2 g | 2 g |
| | ZnO | 1 g | 1 g | 1 g | 1 g | 1 g | 1 g |
| | MgO | 2 g | 2 g | 2 g | 2 g | 2 g | 2 g |
| | TMPTMA70 | 4.66 g | 4.66 g | 4.66 g | 4.66 g | 4.66 g | 4.66 g |
| | crosslinking agent | 7 g | 7 g | 7 g | 7 g | 7 g | 7 g |
| | (TRIGONOX 17-40B) | | | | | | |
| | | Sample No. | | | | | |
| | Property | MN10-4 | MN11-01 | MN12-01 | MN13-01 | MN14-01 | MN19-01 |
| | Shore Hardness A | 83.6 | 82.9 | 81.6 | 84.8 | 88.7 | 85.7 |
| | vulc. at 165° C. | | | | | | |
| | Tensile Strength | 13.18 | 6.43 | 5.45 | 4.44 | 8.10 | 15.16 |
| | MPa LONG. | | | | | | |
| | Elongation at break (%) | 99.2 | 35.7 | 86.0 | 21.5 | 21.3 | 114.2 |
| | Abrasion TABER (mg) | 0.011 | 0.008 | 0.021 | 0.004 | 0.043 | 0.013 |
| | Resistance Ω | 100 | 370 | 274 | 415 | 6000 | 45 |

Inserting polypropylene (pp), which is found in the TPV, into an EPDM matrix does not produce any reduction in the properties of the rubber, and even improves some of the characteristics. The introduction of polypropylene into an EPM matrix does not produce a similar improvement. The presence of MAH produces even less desirable properties.

As can be seen from the results, TPV additive improves the properties of EPDM rubber without any other additives. It also provides improved properties when working with the precursor in a laser engraving machine. Adding TPV to EPM and to MAH grafted EPM should improve the physical properties and durability of the rubber at high temperatures as well.

### Example 10

The effect on the physical properties of an EPDM or EPM matrix into which a ppEPDM-based TPV (samples M01-1, M02-1, and M05-1) or a silicone-based TPV that consists of fully cured silicone rubber particles dispersed in a continuous thermoplastic silicone rubber phase (samples M06-1, M07-1, and M10-1) was investigated. The results are summarized in Table 6.

TABLE 6

| | | Sample No. | | | | | |
|---|---|---|---|---|---|---|---|
| | Component | M01-1 | M02-1 | M05-1 | M06-1 | M07-1 | M10-1 |
| EPDM | ROYALENE 525 | 100 g | | | 100 g | | |
| | VISTALON 404 | | 100 g | | | 100 g | |
| | KEPA 1130 | | | 100 g | | | 100 g |
| | ppEPDM | 100 g | 100 g | 100 g | | | |
| | TPSiV-PDMS-TPV | | | | 100 g | 100 g | 100 g |
| | TMPTMA 70 | 4.66 g | 4.66 g | 4.66 g | 4.66 g | 4.66 g | 4.66 g |
| | crosslinking agent | 7 g | 7 g | 7 g | 7 g | 7 g | 7 g |
| | (TRIGONOX 17-40B) | | | | | | |
| | | Sample No. | | | | | |
| | Property | M01-1 | M02-1 | M05-1 | M06-1 | M07-1 | M10-1 |
| | Shore Hardness A vulc. at 165° C. | 68.1 | 66.4 | 77.3 | 62.6 | 51.9 | 70.0 |
| | Tensile Strength MPa LONG. | 10.41 | 3.18 | 4.28 | 7.23 | 3.77 | 6.97 |
| | Elongation at break (%) | 238.0 | 38.7 | 23.7 | 280.0 | 424.0 | 198.3 |

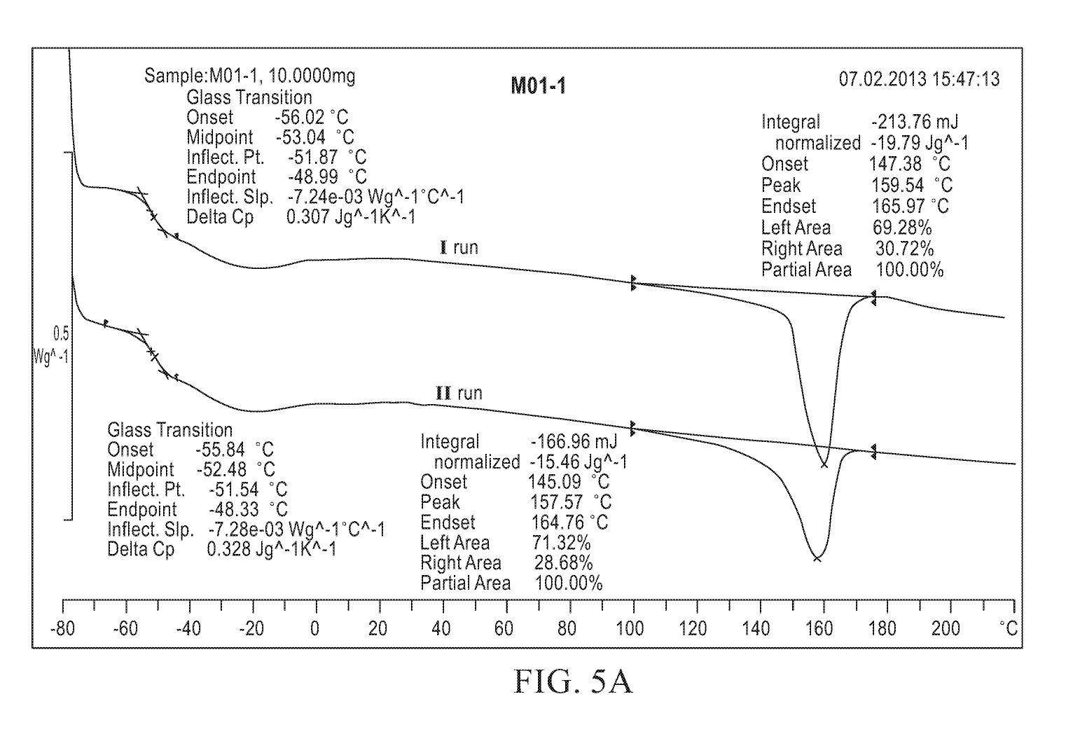

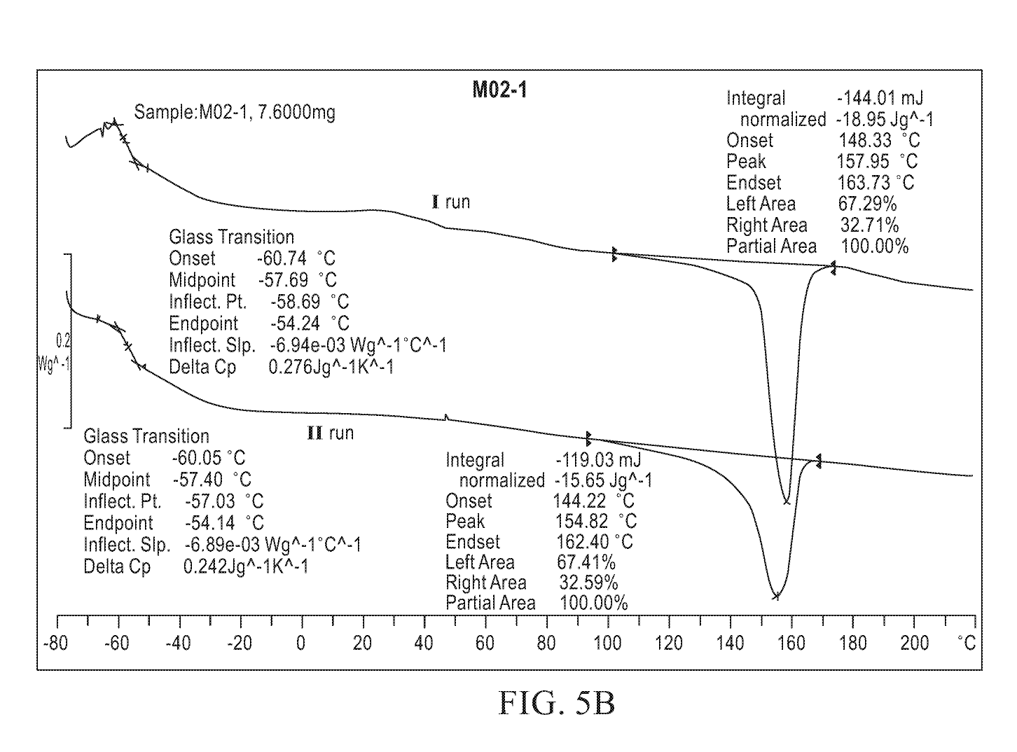

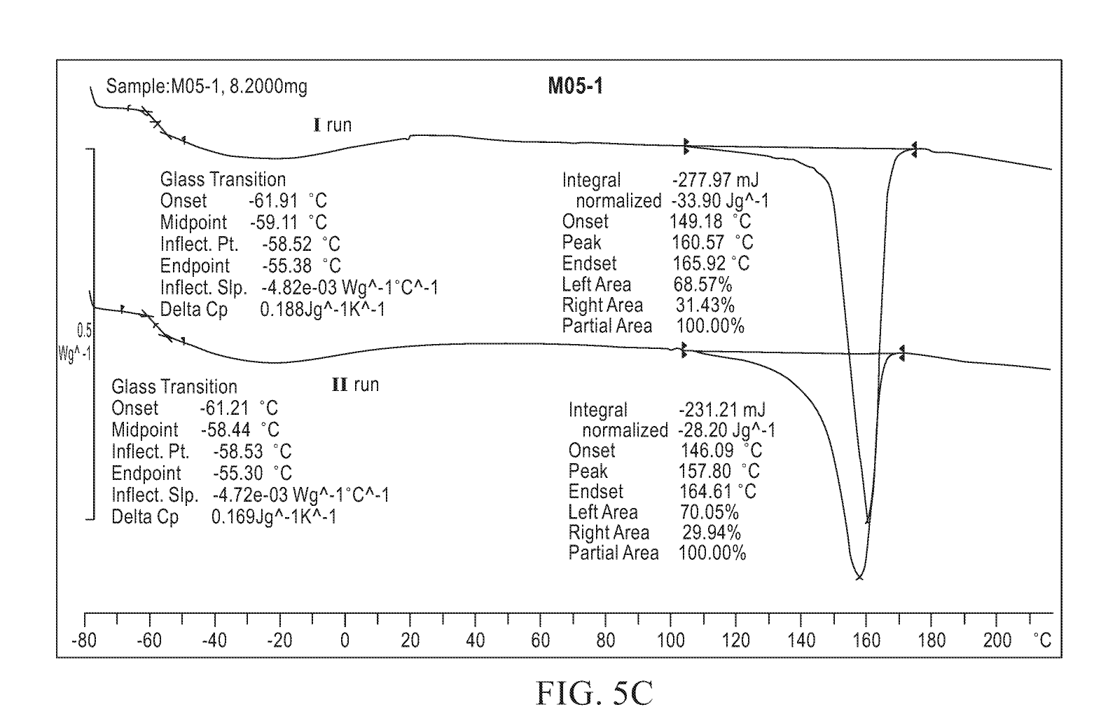

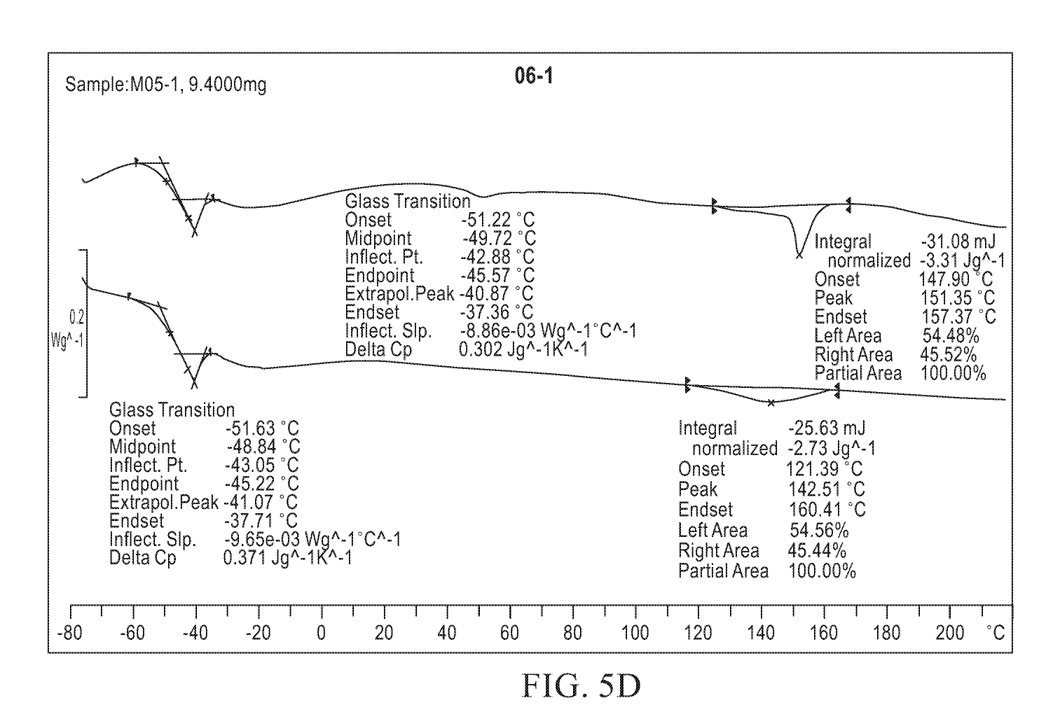

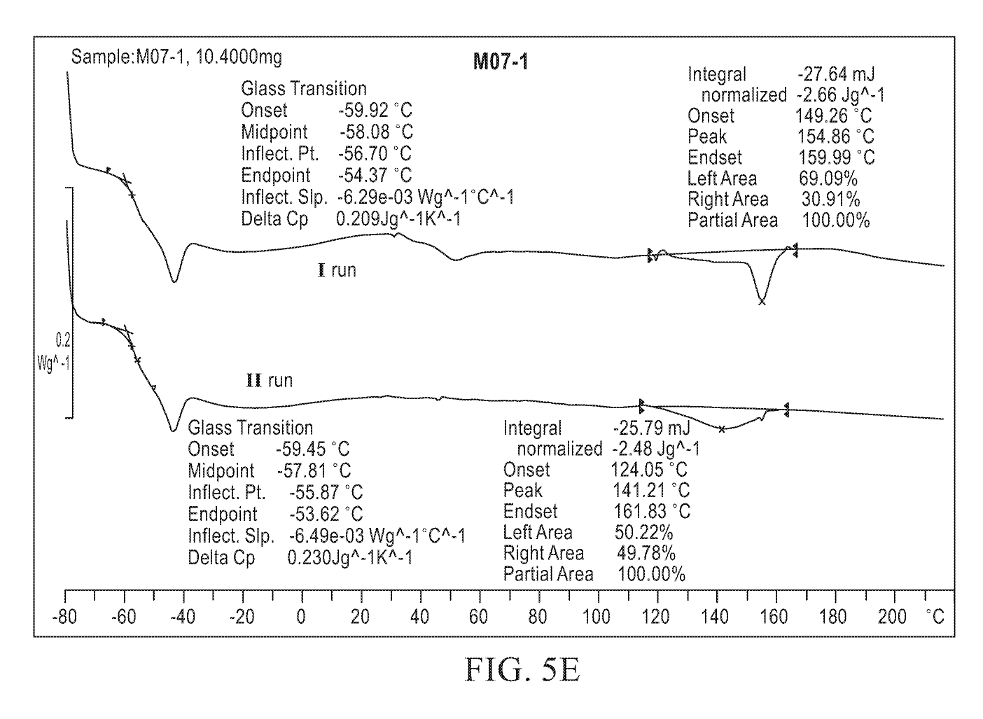

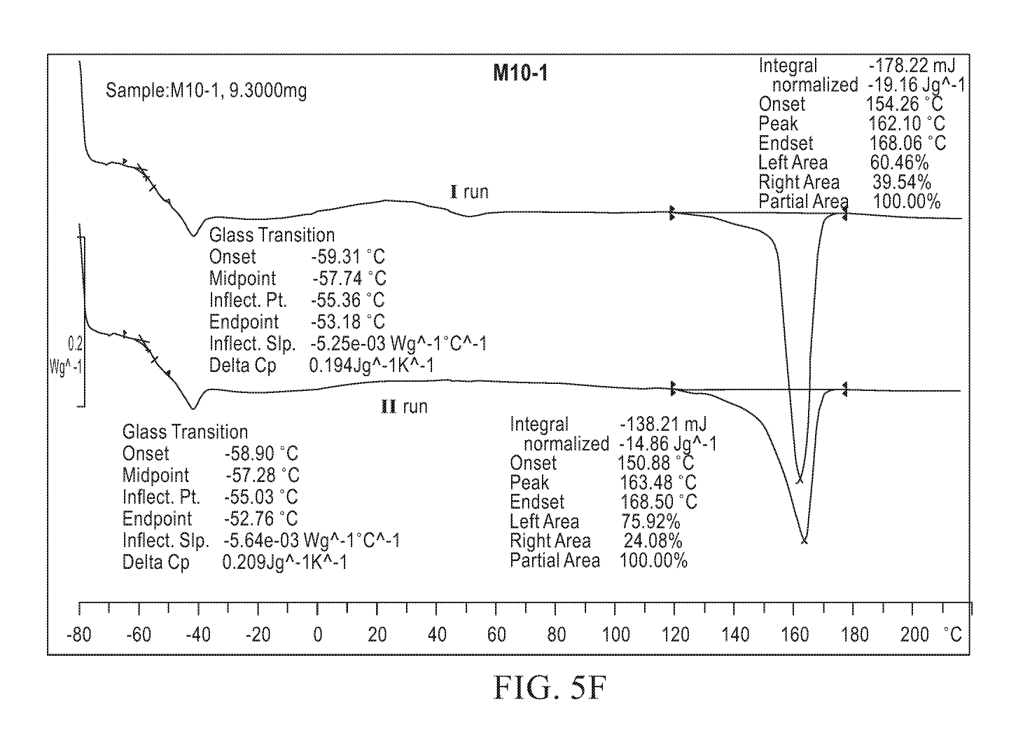

Reference is now made to FIGS. 5A-5F, which present DSC traces for the six compositions listed in Table 5.

The results summarized in the table and illustrated in the accompanying DSC traces demonstrated that it is possible to produce composites of these materials, and that these composites have useful physical properties as well.

### Example 11

A series of compositions were prepared, analogous to those presented in the previous examples except that NBR (EUROPRENE 3345) was used instead of EPDM or EPM. A silica filler (VULCASIL S) was used. The compositions and some of their physical properties are summarized in Table 7.

TABLE 7

| | Sample No. | | | |
|---|---|---|---|---|
| | NBR2-6 | NBR2-8 | NBR2-11 | NBR2-13 |
| Component | | | | |
| NBR | 100.00 | 100.00 | 100.00 | 100.00 |
| Silica | 30.00 | 30.00 | 30.00 | 30.00 |
| Stearic acid | 1.25 | 1.25 | 1.25 | 1.25 |
| ZnO | 6.15 | 6.15 | 6.15 | 6.15 |
| acrylonitrile/butadiene/styrene | 100.00 | | | |
| copolymer (ABS) | | | | |
| styrene/acrylonitrile | | 50.00 | | |
| copolymer (SAN) | | | | |
| Thermoplastic Poly-Urethane | | | 50.00 | 137.40 |
| (TPU) | | | | |
| Carbon Black N550 | 30.00 | 30.00 | 30.00 | 30.00 |
| plasticizer TP 90 B | 5.00 | 5.00 | 5.00 | 5.00 |
| N-isopropyl-N′-phenyl-p- | 1.00 | 1.00 | 1.00 | 1.00 |
| phenylenediamine | | | | |
| (VULCANOX 4010) | | | | |
| C₁₉H₂₈O₄ (VULCAZON | 1.00 | 1.00 | 1.00 | 1.00 |
| AFS-LG) | | | | |
| sulfur | 1.88 | 1.88 | 1.88 | 1.88 |
| TMTM RH 80 | 2.00 | 2.00 | 2.00 | 2.00 |
| Property | | | | |
| Shore Hardness M vulc. at | 91.40 | 79.20 | 62.10 | 61.40 |
| 160° C. | | | | |
| Shore Hardness A vulc. at | 97.00 | | | 60.00 |
| 160° C. | | | | |
| Tensile Strength | 5.38 | 1.70 | 3.32 | 3.07 |
| MPa LONG. | | | | |
| Elongation at break (%) | 21.50 | 47.00 | 418.60 | 290.60 |
| Abrasion TABER (mg) | 0.03 | 0.05 | 0.04 | 0.06 |

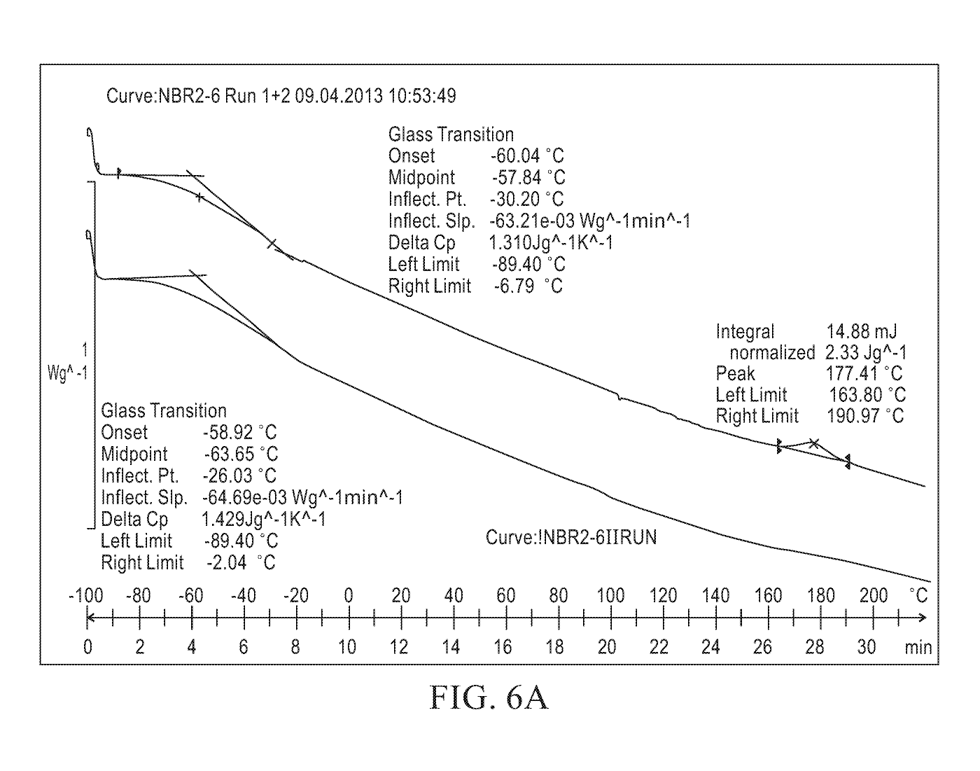

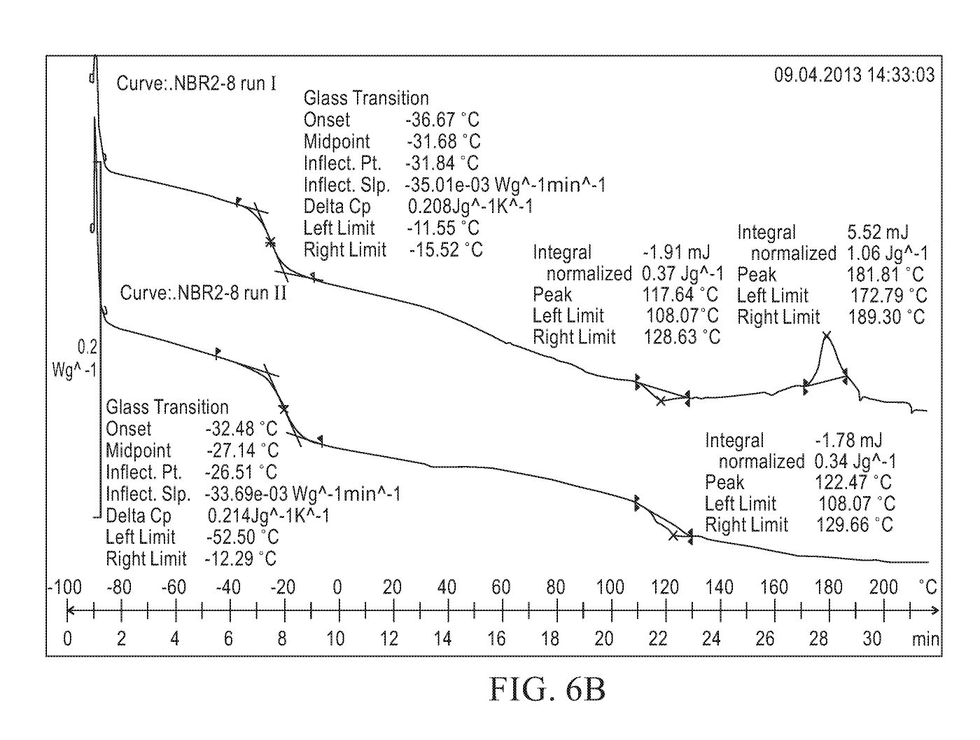

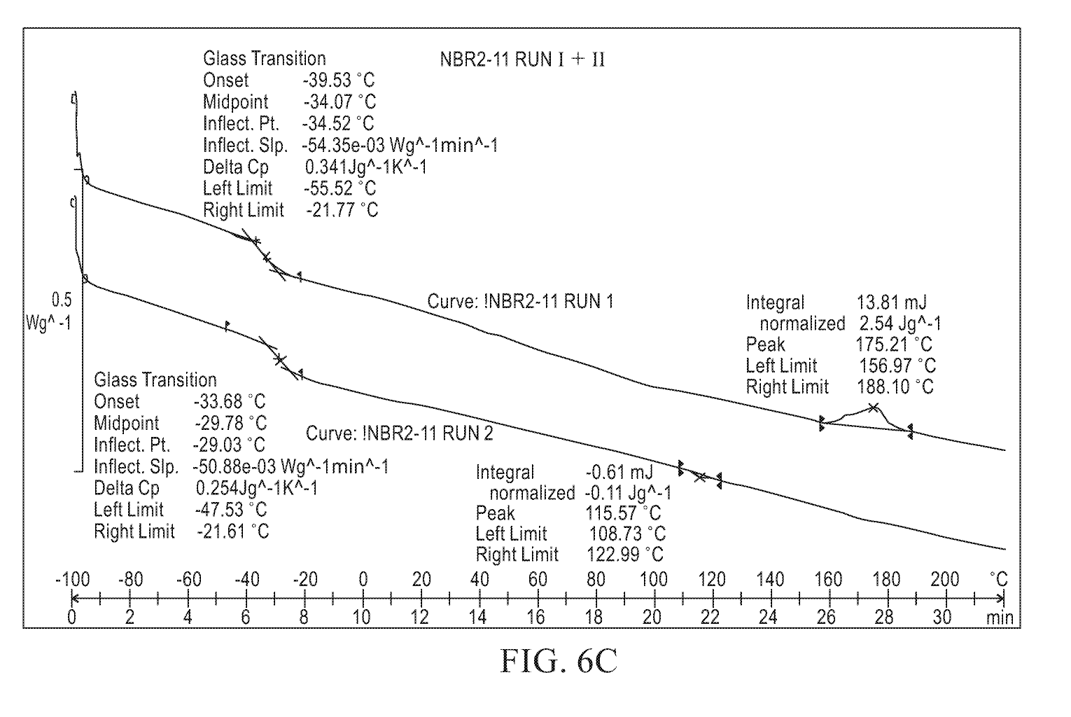

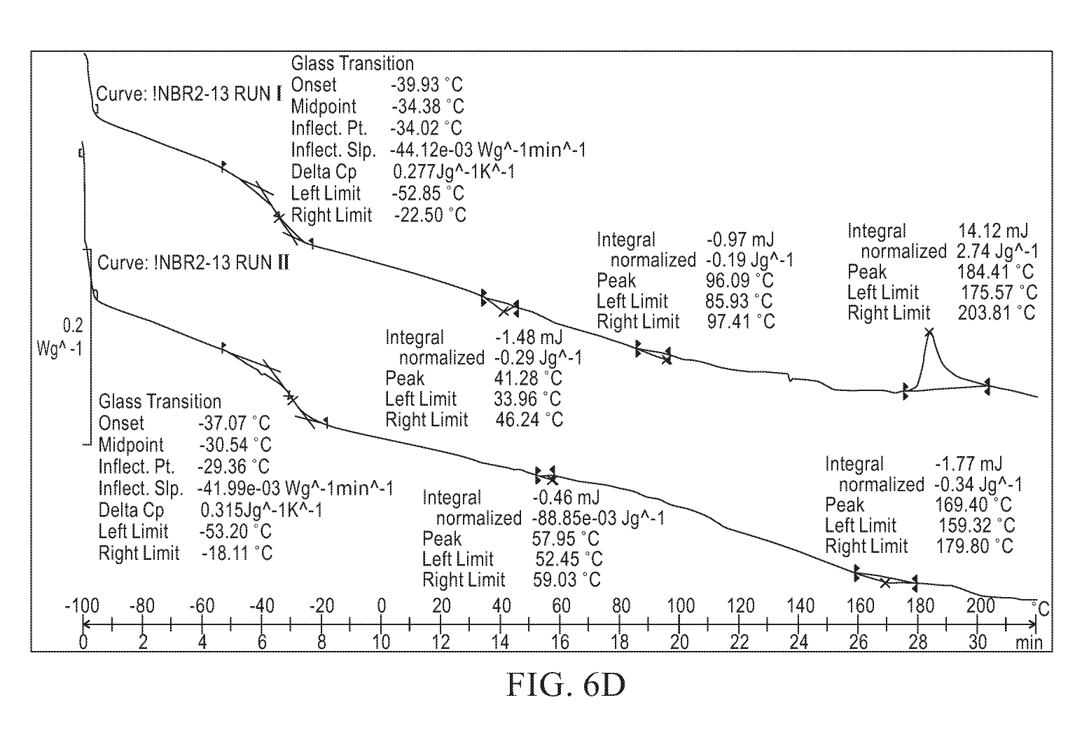

Reference is now made to FIG. 6, which presents DSC traces for the four compositions. No evidence for melting is found. Furthermore, these results demonstrate that incorporation of a thermoplastic material without microparticles of rubber will not produce a thermoplastic phase.

### Example 12

A number of embodiments of the invention herein disclosed are suitable for use as PCMs. Typical compositions of these embodiments are presented in Tables 8 and 9.

TABLE 8

| | | Sample No. | | | |
|---|---|---|---|---|---|
| | | PCM | | | |
| | Component | 2-1 | PCM 2-6 | PCM 2-7 | PCM 2-10 |
| EPDM | ROYALENE 525 | | | 100 | 100 |
| | KEPA 1130 | 100 | 100 | | |
| | High-density | 100 | 200 | 100 | 200 |
| | polyethylene | | | | |
| | carbon black | 55 | 55 | 55 | 55 |
| | polyethylene AC6 | 2 | 2 | 2 | 2 |
| | ZnO | 1 | 1 | 1 | 1 |
| | MgO | 2 | 2 | 2 | 2 |
| | TMPTMA 70% | 4.66 | 4.66 | 4.66 | 4.66 |
| | crosslinking agent | 7 | 7 | 7 | 7 |
| | (TRIGONOX | | | | |
| | 17-40) | | | | |

TABLE 9

| | Sample No. | | | | | | |
|---|---|---|---|---|---|---|---|
| | PCM | PCM | PCM | PCM | PCM | PCM | PCM |
| Component | 1-2 | 1-3 | 1-4 | 1-7 | 1-8 | 1-9 | 1-10 |
| polyacrylate (ACM) | 100 | 100 | 100 | 100 | 100 | 100 | 100 |
| Zeon-Zeotherm ® | 100 | | 100 | 50 | 200 | 100 | 200 |
| TPV (ACM) | | | | | | | |
| nylon 6 polyamide | | 100 | 100 | 50 | 100 | 200 | 200 |
| CB N550 | 55 | 55 | 55 | 55 | 55 | 55 | 55 |
| antioxidant | 2 | 2 | 2 | 2 | 2 | 2 | 2 |
| (NUAGRAD 445) | | | | | | | |
| Stearic Acid | 0.5 | 0.5 | 0.5 | 0.5 | 0.5 | 0.5 | 0.5 |
| Polyoxyethylene | 1 | 1 | 1 | 1 | 1 | 1 | 1 |
| octadecyl ether | | | | | | | |
| phosphate (Vanfre VAM) | | | | | | | |
| Distilled octadecyl amine | 0.5 | 0.5 | 0.5 | 0.5 | 0.5 | 0.5 | 0.5 |
| (ARMEEN 18D) | | | | | | | |
| Lubricant (Vanfre VAM) | 1 | 1 | 1 | 1 | 1 | 1 | 1 |
| VULCOFAC ACT 55 | 2 | 2 | 2 | 2 | 2 | 2 | 2 |
| 1-(6- | 1.2 | 1.2 | 1.2 | 1.2 | 1.2 | 1.2 | 1.2 |
| Aminohexyl)carbamic | | | | | | | |
| acid | | | | | | | |
| polyethylene AC6 | 0.6 | 0.6 | 0.6 | 0.6 | 0.6 | 0.6 | 0.6 |
| plasticizer (RHENOSIN | 10 | 10 | 10 | 10 | 10 | 10 | 10 |
| W 759) | | | | | | | |

### Example 13

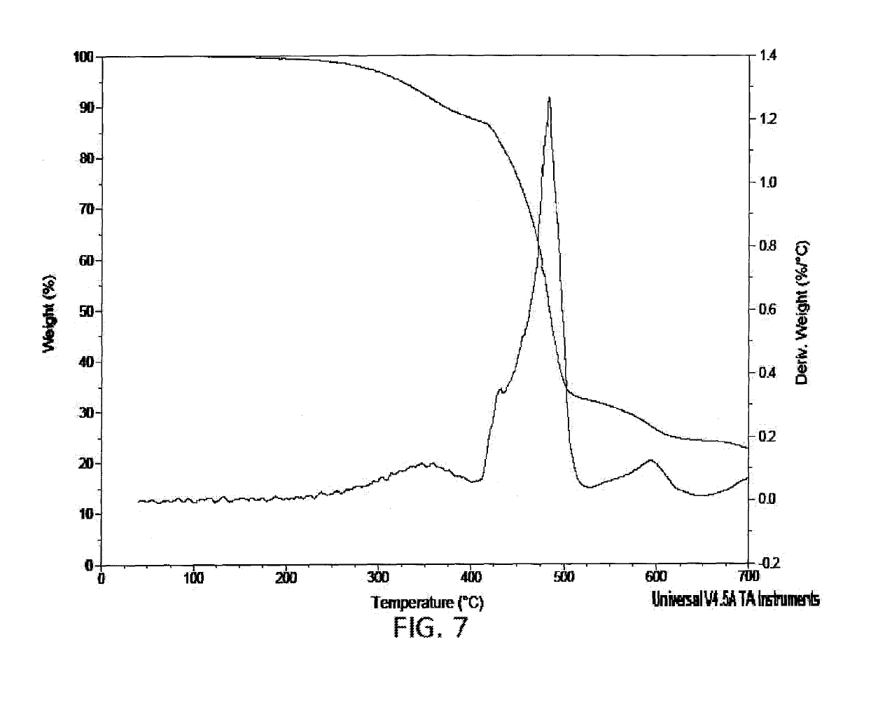

For purposes of comparison, a rubber composition lacking TPV, similar to those known in the art, was prepared. The composition consisted of 100 parts EPDM, 30 parts plasticizer, 12 parts carbon black, 32 parts silica, 6 parts silane, 6 parts ZnO, 1 part stearic acid, 10 parts peroxide cross-linking agent, and 1.5 parts TAC. Reference is now made to FIG. 7, which presents the results of a TGA analysis of this composition. The TGA was performed under the same conditions as were used in the TGA analysis shown in FIG. 2. As can be seen in the figure, more than 20% of the initial weight remains after the conclusion of the TGA run, in contrast to the compositions of the present invention, in which essentially none of the material initially present remains. Also, unlike the compositions of the present invention, there is no single sharp derivative peak corresponding to oxidation of the carbon black contained within the composition.

We claim:

1. A method for making a precursor to an elastomeric material comprising:
mixing rubber and at least one material selected from TPV, thermoplastic incorporating microparticles of rubber, and any combination thereof; and
adding at least one cross-linking agent.

2. The method according to claim 1, wherein the mixing step is performed with an apparatus selected from mixers, extruders, and mills.

3. The method according to claim 1, wherein the mixing step comprises mixing at an operating temperature above the melting point of said TPV.

4. The method according to claim 1, wherein the mixing step comprises mixing at an operating temperature of about 150° C. to 270° C.

5. A method of making an elastomeric material comprising the steps for making a precursor to an elastomeric material by the method of claim 1; and
activating said cross-linking agent.

6. A roofing material, sealing material, automotive component, medical device, protective clothing, concertina bellows for buses or trains, an inflatable product, a membrane, or a diaphragm comprising a precursor to an elastomeric material, wherein said precursor comprises:
a rubber;
a material incorporated into the rubber, said material comprising thermoplastic vulcanizate (TPV), microparticles of TPV, thermoplastic incorporating microparticles of rubber, or any combination thereof; and
at least one cross-linking agent.

7. A microfluidic device made from a precursor to an elastomeric material, wherein said precursor comprises:
a rubber;
a material incorporated into the rubber, said material comprising thermoplastic vulcanizate (TPV), microparticles of TPV, thermoplastic incorporating microparticles of rubber, or any combination thereof; and
at least one cross-linking agent.

8. A precursor to an elastomeric material, wherein said precursor comprises:
a rubber;
a material incorporated into the rubber, said material comprising thermoplastic vulcanizate (TPV), microparticles of TPV, thermoplastic incorporating microparticles of rubber, or any combination thereof;
at least one cross-linking agent; and a phase change material.
